(19) United States
(12) Patent Application Publication
(10) Pub. No.: US 2026/0347640 A1
(43) Pub. Date: Nov. 5, 2026

(54) OLIGOMERS COMPRISING POLYMERIZED HIGH-TG MONOMERS

(71) Applicant: Arkema France, Colombes (FR)

(72) Inventors: Jon SCHOLTE, Exton, PA (US); Christopher MACNEILL, Exton, PA (US); Renee KONTOS, King of Prussia, PA (US); Linda FRANCESCHINI, Exton, PA (US); Philippe CICERON, Senlis (FR); Kevin DEMOULIN, Verneuil En Halatte (FR); Pierre MELEC, Verneuil En Halatte (FR); Christophe VERGE, Verneuil En Halatte (FR); Donald HERR, Exton, PA (US)

(21) Appl. No.: 18/995,211

(22) PCT Filed: Jul. 20, 2023
(86) PCT No.: PCT/EP2023/070238

§ 371 Date: Jan. 16, 2025

(30) Foreign Application Priority Data
Jul. 20, 2022 (EP) 22.306078.1

(51) Int. Cl. C09D 133/14; C08F 220/14; C08F 220/18; C08F 220/68; C09D 135/02

(52) U.S. Cl. CPC C09D 133/14; C08F 220/14; C08F 220/1804; C08F 220/1809; C08F 220/1811; C08F 220/68; C09D 135/02; C08F 2800/20

(57) ABSTRACT

The present invention relates to an oligomer comprising polymerized high-T_{g} monomer units, polymerized low-T_{g} monomer units, polymerized chromophore monomer units, and optionally at least one polymerized additional monomer unit. The invention also relates to an ultraviolet curable composition comprising the oligomer, and a coating formed from curing the ultraviolet curable composition.

### TECHNICAL FIELD

The present invention relates to an oligomer. The oligomer comprises polymerized high T_{g} monomer units, polymerized low T_{g} monomer units, polymerized chromophore monomer units, and optionally at least one polymerized additional monomer unit. The invention also relates to use of the curable composition as a coating and methods of coating a substrate.

### BACKGROUND

Oligomers having acrylic polymerized monomers and chromophores can generally be crosslinked via irradiation with ultraviolet (UV light), but have certain drawbacks during processing. For example, oligomers having a T_{g} of equal to or greater than 0 °C can be difficult to sufficiently crosslink, which may weaken coatings and adhesives derived therefrom. Such difficulty limits their application due to performance requirements.

Oligomers having a T_{g} of equal to or greater than 0 °C can be processed to form high-T_{g} coatings and adhesives that offer advantages over low-T_{g} coatings and adhesives formed from oligomers having a T_{g} of less than 0 °C, such as improved hardness. However, it may be challenging to develop such oligomers that realize desired characteristics, such as sufficient crosslinking upon curing. Thus, there is a need for oligomers having a T_{g} of equal to or greater than 0 °C while maintaining high crosslinking upon curing.

Embodiments of the oligomers disclosed herein overcome drawbacks associated with known oligomers having a T_{g} of equal to or greater than 0 °C.

### SUMMARY

A first aspect disclosed herein is a an oligomer comprising, based on the total weight of the oligomer: from 1% to 95% by weight polymerized high-T_{g} monomer units, from 0.1% to 98.9% by weight polymerized low-T_{g} monomer units, from 0.1% to 40% by weight polymerized chromophore monomer units, and from 0 to 20% by weight of at least one polymerized additional monomer unit; wherein: the high-T_{g} monomer units are (meth)acrylate monomers having a Fox Equation average glass transition temperature (T_{g}) equal to or greater than 25 °C; the low-T_{g} monomer units are monovalent (meth)acrylate monomers having a Fox Equation average T_{g} less than 25 °C; the Fox Equation average T_{g} of the high-T_{g} monomer units is at least 20 °C greater than the Fox Equation average T_{g} of the low-T_{g} monomer units; the chromophore monomer units are (meth)acrylate monomers having a pendent Norrish Type II chromophore; the oligomer has a weight average molecular weight of at least 10,000 grams per mole (g/mol); and the oligomer has a T_{g} equal to or greater than 0 °C.

Another aspect disclosed herein is an curable composition comprising the oligomer and a reactive diluent.

Another aspect disclosed herein is a coating formed by curing the ultraviolet curable composition.

Another aspect disclosed herein is a method of preparing the curable composition of the invention, wherein the method comprises the following steps:
preparing an oligomer according to the invention dissolved in a non-reactive solvent;
adding a reactive diluent to obtain a diluted curable composition;
removing at least part of the non-reactive solvent from the diluted curable composition to obtain the curable composition.

Another aspect disclosed herein is a method of curing the curable composition of the invention or prepared by the method of the invention wherein the method comprises curing a curable composition comprising an oligomer and a reactive diluent by irradiating the curable composition with a light source having a wavelength and/or an intensity that is able to activate the polymerized chromophore monomer units of the oligomer and cause crosslinking of said oligomer and/or said reactive diluent.

This summary is provided to introduce a selection of concepts that are further described in the detailed description. This summary is not intended to identify key or essential features of the claimed subject matter, nor is it intended to be used as an aid in limiting the scope of the claimed subject matter.

Additional features and advantages of the described embodiments will be set forth in the detailed description that follows. The additional features and advantages of the described embodiments will be, in part, readily apparent to those skilled in the art from that description or recognized by practicing the described embodiments, including the detailed description that follows as well as the drawings and the claims.

### DESCRIPTION OF DRAWINGS

FIG. 1 is a graph of gel content of cured comparative examples and examples according to one or more embodiments described herein;

FIG. 2 is a graph of gel content of cured comparative examples and examples according to one or more embodiments described herein;

FIG. 3 is a graph of gel content of cured comparative examples and examples according to one or more embodiments described herein;

FIG. 4 is a graph of gel content of cured comparative examples and examples according to one or more embodiments described herein;

FIG. 5 is a graph of gel content of cured comparative examples and examples according to one or more embodiments described herein;

FIG. 6 is a graph of cure speed of comparative examples and examples according to one or more embodiments described herein;

FIG. 7 is a graph of cure speed of comparative examples and examples, according to one or more embodiments described herein.

Reference will now be made in greater detail to various embodiments, some embodiments of which are illustrated in the accompanying drawings.

### DETAILED DESCRIPTION

### Definitions

As used herein, the term “comprises a” can mean “comprises one or more”.

Unless otherwise mentioned, the weight percentages in a compound or a composition are expressed relative to the weight of the compound, respectively of the composition.

The term “substitution” herein means that at least one hydrogen atom (—H) bonded to a carbon atom or heteroatom of a corresponding unsubstituted compound or functional group is replaced by a substituent (e.g. R^{S}). The term “persubstitution” means that every hydrogen atom (H) bonded to a carbon atom or heteroatom of a corresponding unsubstituted compound or functional group is replaced by a substituent (e.g., R^{S}). The term “polysubstitution” means that at least two, but fewer than all, hydrogen atoms bonded to carbon atoms or heteroatoms of a corresponding unsubstituted compound or functional group are replaced by a substituent. Unless otherwise defined or limited in a specific context, a substituent group generally, or a substituent group referred to as R^{S}, may be any chemical moiety, typically, but not necessarily limited to, a chemical moiety having from 1 to 50, or from 1 to 40, or from 1 to 30, or from 1 to 20, or from 1 to 10 total atoms. Examples of substituent groups R^{S} include, but are not limited to, a hydrocarbyl, a heterohydrocarbyl, an aryl, a heteroaryl, an alkyl, a cycloalkyl, a heteroatom, a carbonyl, a hydroxy, an ester, an ether, an amine, an amide, or a halide according to their respective definitions herein or their commonly understood meaning, any of which substituents themselves may be substituted or unsubstituted. In some embodiments, substituents R^{S} may be chosen from a (C₁-C₃₀)hydrocarbyl, a (C₁-C₃₀)heterohydrocarbyl, a (C₆-C₃₀)aryl, or a (C₆-C₃₀)heteroaryl.

The term “hydrocarbyl” means a monovalent hydrocarbon, in which each hydrocarbon is aromatic or non-aromatic, saturated or unsaturated, straight chain or branched chain, cyclic (having three carbons or more, and including mono- and poly-cyclic, fused and non-fused polycyclic, and bicyclic) or acyclic, and substituted by one or more R^{S}, or unsubstituted. In this disclosure, hydrocarbyl may be an unsubstituted or substituted alkyl, an unsubstituted or substituted cycloalkyl, or an unsubstituted or substituted aryl. A hydrocarbyl may not comprise any heteroatom selected from O, N or S. A (C₁-C₃₀)hydrocarbyl is a hydrocarbyl having from 1 to 30 carbon atoms.

The term “heterohydrocarbyl” means a hydrocarbyl bearing one or more heteroatoms independently selected from O, N or S. A (C₁-C₃₀)heterohydrocarbyl is a heterohydrocarbyl having from 1 to 30 carbon atoms.

The term “aryl” means an optionally substituted polyunsaturated aromatic group. The aryl may contain a single ring (i.e. phenyl) or more than one ring wherein at least one ring is aromatic. When the aryl comprises more than one more ring, the rings may be fused, linked via a covalent bond (for example biphenyl). The aromatic ring may optionally comprise one to two additional fused rings (i.e. cycloalkyl, heterocycloalkyl or heteroaryl). Examples include phenyl, naphthyl, biphenyl, phenanthrenyl and naphthacenyl.

The term “alkyl” means a monovalent saturated acyclic hydrocarbon group of formula —CₙH₂ₙ₊₁ wherein n is 1 to 20. An alkyl may be linear or branched. Examples of alkyl groups include methyl, ethyl, propyl, isopropyl, butyl, isobutyl, tert-butyl, pentyl, hexyl, 2-methylbutyl, 2,2-dimethylpropyl, n-hexyl, 2-methylpentyl, 2,2-dimethylbutyl, n-heptyl, 2-ethylhexyl, and the like.

The term “cycloalkyl” means a monovalent saturated alicyclic hydrocarbon group comprising a cycle. Examples of cycloalkyl groups include cyclopentyl, cyclohexyl, and isobornyl, any of which may be substituted or unsubstituted.

The term “heterocycloalkyl” means a cycloalkyl having at least one ring atom that is a heteroatom selected from O, N, or S.

The term “halogen” means an atom selected from Cl, Br, F and I.

The term “alkoxy” means a group of formula —O-alkyl, wherein the alkyl is as defined above.

The term “aryloxy” means a group of formula —O-aryl, wherein the aryl is as defined above.

The term “thioalkyl” means a group of formula —S-alkyl, wherein the alkyl is as defined above.

The term “thioaryl” means a group of formula —S-aryl, wherein the aryl is as defined above.

The term “alkenyl” means a monovalent acyclic hydrocarbon group comprising at least one C═C double bond. An alkenyl may be linear or branched.

The term “alkynyl” means a monovalent acyclic hydrocarbon group comprising at least one C≡C triple bond. An alkynyl may be linear or branched.

The term “aralkyl” means an aryl substituted by an alkyl group. An example of an aralkyl group is tolyl.

The term “alkaryl” means an alkyl substituted by an aryl group. An example of an alkaryl group is benzyl (—CH₂-Phenyl).

The term “heteroaryl” means an aryl having at least one ring atom that is a heteroatom.

The term “alkylamino” means an alkyl substituted by at least one amino group.

The term “alkylthiol” means an alkyl substituted by at least one thiol group

The term “hydroxyalkyl” means an alkyl substituted by at least one hydroxy group.

The term “haloalkyl” means an alkyl substituted by at least one halogen.

The term “alkylene” or “alkanediyl” means a linker derived from an alkane of formula CₘH₂ₘ₊₂ by removing one hydrogen atom at each point of attachment of the linker. An alkylene may be divalent, trivalent, tetravalent or have even higher valencies.

The term “alkoxylated” means a compound, group or linker containing one or more oxyalkylene moieties, in particular one or more oxyalkylene selected from oxyethylene (—O—CH₂—CH₂—), oxypropylene (—O—CH₂—CH(CH₃)— or —O—CH(CH₃)—CH₂—), oxybutylene (—O—CH₂—CH₂—CH₂—CH₂—) and mixtures thereof. For example, an alkoxylated compound, group or linker may contain from 1 to 30 oxyalkylene moieties.

The term “(meth)acrylate” means acrylate or methacrylate. The term “acrylate” means an acryloyloxy group (—O—C(═O)—CH═CH₂). The term “methacrylate” means a methacryloyloxy group (—O—C(═O)—C(CH₃)═CH₂).

The term (meth)acrylate monomer means a monomer bearing a (meth)acrylate group.

As used herein, the “monomers” have a number average molecular weight of less than 1,000 g/mol, preferably 100 to 950 g/mol.

As used herein, the “oligomers” have a number average molecular weight from equal to or more than 1,000 g/mol, preferably 1,050 to 60,000 g/mol, more preferably 10,000 to 50,000 g/mol.

The term “glass transition temperature” or “T_{g}” refers to the temperature at which a material changes from a glassy state to a rubbery state. In this context, the term “glassy” means that the material is hard and brittle while the term “rubbery” means that the material is elastic and flexible. For polymeric materials, the T_{g} is the critical temperature that separates their glassy and rubbery behaviors. If a polymeric material is at a temperature below its T_{g}, large-scale molecular motion is severely restricted because the material is essentially frozen. On the other hand, if the polymeric material is at a temperature above its T_{g}, molecular motion on the scale of its repeat unit takes place, allowing it to be soft or rubbery.

All references herein to a T_{g} of a monomer refer to the T_{g} of a homopolymer formed from that monomer. T_{g} values of common monomers are well-known from literature. If not reported in the literature, glass transition temperature values may be determined in accordance with ASTM E1356-08, “Standard Test Method for Assignment of the Glass Transition Temperatures by Differential Scanning Calorimetry” as the inflection temperature (Tᵢ). The glass transition temperatures of the oligomers described herein and mentioned in the examples below are calculated using the Fox Equation based on the mass fractions and T_{g} values of each individual monomer of the oligomer or polymeric material that includes more than one discrete type of monomer.

The terms “mass fraction” and “weight fraction” are used herein interchangeably and are to be regarded as equivalent to each other with respect to embodiments or examples herein.

The “Fox Equation” refers to equation (1):

1/T_{g,mix}≈Σᵢωᵢ/T_{g,i} equation (1)

where T_{g, mix} is the glass transition temperature of a mixture of i chemically discrete components, such as two or more discrete monomers of an oligomer or polymer, T_{g,i} is the glass transition temperature of the i-th component, and ωᵢ is the mass fraction of the i-th component, based on the total mass of the oligomer or polymer. Hereinafter, the value T_{g,mix} with respect to multiple discrete monomers in an oligomer or polymer is referred to as the “Fox Equation average T_{g}” of the multiple discrete monomers.

For two components of each type of monomer, A and B, the Fox Equation reduces to equation (2):

1/T_{g,mix}≈ω_{A}/T_{g,}_{^{A}}+ω_{B}/T_{g,}_{^{B}} equation (2)

The term “high-T_{g} monomer unit” refers to a monomer that, when homopolymerized, produces a homopolymer having a T_{g} of equal to or greater than 25 °C. In embodiments of the oligomer, for which only one kind of high-T_{g} monomer unit is present in the oligomer, the T_{g} of the high-T_{g} monomer units is the T_{g} of a homopolymer of the one kind of high-T_{g} monomer unit. In embodiments of the oligomer, for which two or more types of distinct high-T_{g} monomer units are present in the oligomer, the T_{g} of the high-T_{g} monomer units of the oligomer collectively refers to the Fox Equation average T_{g} of the combination of the high-T_{g} monomer units, in which for equation (1) the individual mass fractions ωᵢ are mass fractions of each individual high-T_{g} monomer unit in the oligomer, based on the total mass of all the high-T_{g} monomer units present in the oligomer (that is, the monomer units having a T_{g} of equal to or greater than 25 °C), not on the total mass of the oligomer as a whole.

The term “Fox Equation average” may be used herein even with respect to a single monomer that is not part of a mixture of two or more monomers. It should be readily understood that a Fox Equation average T_{g} with respect to a single monomer is equivalent to the T_{g} of the single monomer itself, as defined herein, as the term mass fraction term ω in such a situation would equal one.

The term “low-T_{g} monomer unit” refers to a monomer that, when homopolymerized, produces a homopolymer having a T_{g} of less than 25 °C. In embodiments of the oligomer, for which only one kind of low-T_{g} monomer unit is present in the oligomer, the T_{g} of the low-T_{g} monomer units is the T_{g} of a homopolymer of the one kind of low-T_{g} monomer unit.

In embodiments of the oligomer, for which two or more types of distinct low-T_{g} monomer units are present in the oligomer, the T_{g} of the low-T_{g} monomer units of the oligomer collectively refers to the Fox Equation average T_{g} of the combination of the low-T_{g} monomer units, in which for equation (1) the individual mass fractions C₀ are mass fractions of each individual low-T_{g} monomer unit in the oligomer, based on the total mass of all the low-T_{g} monomer units present in the oligomer (that is, the monomer units having a T_{g} of less than 25 °C), not on the total mass of the oligomer as a whole.

The term “photoinitiator”, may be considered any type of substance that, upon exposure to radiation (e.g., actinic radiation), forms species that initiate the reaction and curing of polymerizing organic substances present in a curable composition.

The term “chromophore” refers herein to a Norrish Type II light absorbing molecule that enters an excited state upon absorbing light. From this excited state, the molecule can interact or react with other molecules to produce reactive radical species.

When used to describe certain carbon atom-containing chemical groups, an expression having the form “A¹-A⁴” refers to each A^{x} group within the range from A¹ to A⁴, inclusive of 1 and 4. For example, an expression having the form “A¹-A⁴” refers to A¹, A², A³, and A⁴. An expression having the form “Z¹-Z⁴” refers to each Z^{x} group within the range from Z¹ to Z⁴, inclusive of 1 and 4. For example, an expression having the form “Z¹-Z⁴” refers to Z¹, Z², Z³, and Z⁴.

The term “independently selected” is used herein to indicate that the substituent groups, such as, Z¹, Z², Z³, and Z⁴, can be identical or different (e.g., Z¹, Z², Z³, and Z⁴ may all be —CH₃ or Z¹ and Z² may be —CH₃ and Z³ and Z⁴ may be —H, etc.) A chemical name associated with a substituent group is intended to convey the chemical structure that is recognized in the art as corresponding to that of the chemical name. Thus, chemical names are intended to supplement and illustrate, not preclude, the structural definitions known to those of skill in the art.

When used to describe certain carbon atom-containing chemical groups, a parenthetical expression having the form “(Cₓ-C_{y})” means that the unsubstituted form of the chemical group has from x carbon atoms to y carbon atoms, inclusive of x and y. For example, a (C₁-C₂₀)hydrocarbyl is a hydrocarbyl group having from 1 to 20 carbon atoms in its unsubstituted form. In some embodiments and general structures, certain chemical groups may be substituted by one or more substituents such as R^{S}. An R^{S} substituted version of a chemical group defined using the “(Cₓ-C_{y})” parenthetical may contain more than y carbon atoms depending on the identity of any groups R^{S}. For example, a “(C₁-C₂₀)alkyl substituted with exactly one group R^{S}, where R^{S} is phenyl (—C₆H₅)” may contain from 7 to 27 carbon atoms. Thus, in general when a chemical group defined using the “(Cₓ-C_{y})” parenthetical is substituted by one or more carbon atom-containing substituents R^{S}, the minimum and maximum total number of carbon atoms of the chemical group is determined by adding to both x and y the combined sum of the number of carbon atoms from all of the carbon atom-containing substituents R^{S}.

The term “—H” means a hydrogen atom that is covalently bonded to an atom other than hydrogen. “Hydrogen” and “—H” are interchangeable, and, unless clearly specified, have identical meanings.

The term “(C₁-C₃₀)hydrocarbyl” means a monovalent hydrocarbon of from 1 to 30 carbon atoms, in which each monovalent hydrocarbon is aromatic or non-aromatic, saturated or unsaturated, straight chain or branched chain, cyclic (having three carbons or more, and including mono- and poly-cyclic, fused and non-fused polycyclic, and bicyclic) or acyclic, and substituted by one or more R^{S}, or unsubstituted. In this disclosure, a (C₁-C₃₀)hydrocarbyl may be an unsubstituted or substituted (C₁-C₃₀)alkyl, (C₃-C₃₀)cycloalkyl, or (C₆-C₃₀)aryl.

The term “(C₂-C₃₀)alkyl” mean a saturated straight or branched monovalent hydrocarbon of from 2 to 30 carbon atoms that is unsubstituted or substituted by one or more R^{S}. Examples of unsubstituted (C₂-C₃₀)alkyl are unsubstituted (C₂-C₂₀)alkyl; unsubstituted (C₆-C₂₅)alkyl; unsubstituted (C₄-C₈)alkyl; 1-butyl; 2-butyl; 2-methylpropyl; 1,1-dimethylethyl; 1-pentyl; 1-hexyl; 1-heptyl; 1-nonyl; and 1-decyl. Examples of substituted (C₂-C₃₀)alkyl are substituted (C₂-C₂₀)alkyl, substituted (C₂-C₁₀)alkyl.

The term “(C₆-C₄₀)aryl” means an unsubstituted or substituted (by one or more R^{S}) monocyclic, bicyclic, or tricyclic aromatic monovalent hydrocarbon of from 6 to 40 carbon atoms, of which at least from 6 to 14 of the carbon atoms are aromatic ring carbon atoms. A monocyclic aromatic monovalent hydrocarbon includes one aromatic ring; a bicyclic aromatic monovalent hydrocarbon has two rings; and a tricyclic aromatic monovalent hydrocarbon has three rings. When the bicyclic or tricyclic aromatic monovalent hydrocarbon is present, at least one of the rings of the monovalent hydrocarbon is aromatic. The other ring or rings of the aromatic monovalent hydrocarbon may be independently fused or non-fused and aromatic or non-aromatic. Examples of unsubstituted (C₆-C₄₀)aryl include: unsubstituted (C₆-C₂₀)aryl, unsubstituted (C₆-C₁₈)aryl; 2-(C₁-C₅)alkyl-phenyl; phenyl; fluorenyl; tetrahydrofluorenyl; idacenyl; hexahydracenyl; hexahydroindacenyl; indenyl; dihydroindenyl; naphthyl; tetrahydronaphthyl; and phenanthrene. Examples of substituted (C₆-C₄₀)aryl include: substituted (C₁-C₂₀)aryl; and substituted (C₆-C₁₈)aryl.

The term “(C₆-C₁₂)cycloalkyl” means a saturated cyclic monovalent hydrocarbon of from 6 to 12 carbon atoms that is unsubstituted or substituted. Other cycloalkyl groups (e.g., (Cₓ-C_{y})cycloalkyl) are defined in an analogous manner as having from x to y carbon atoms and being either unsubstituted or substituted by one or more R^{S}. Examples of unsubstituted (C₆-C₁₂)cycloalkyl are unsubstituted (C₆-C₈)cycloalkyl, unsubstituted (C₆-C₁₀)cycloalkyl, cyclopropyl, cyclobutyl, cyclopentyl, cyclohexyl, cycloheptyl, cyclooctyl, cyclononyl, and cyclodecyl. Examples of substituted (C₆-C₁₂)cycloalkyl are substituted (C₆-C₈)cycloalkyl, substituted (C₆-C₁₀)cycloalkyl, isobornyl, and 3,3,5-trimethylcyclohexyl.

The term “heteroatom,” refers to an atom other than hydrogen or carbon. Examples of heteroatoms include O, S, N, Si. The term “heterohydrocarbon” refers to a molecule or molecular framework in which one or more carbon atoms of a hydrocarbon are replaced with a heteroatom. The term “(C₁-C₃₀)heterohydrocarbyl” means a monovalent heterohydrocarbon of from 1 to 30 carbon atoms, and the term “(C₁-C₃₀)heterohydrocarbylene” means a divalent heterohydrocarbon of from 1 to 30 carbon atoms. The heterohydrocarbon of the (C₁-C₃₀)heterohydrocarbyl or the (C₁-C₃₀)heterohydrocarbylene has one or more heteroatoms. The valency or connection point of the heterohydrocarbyl may be on a carbon atom or a heteroatom. The two valencies of the heterohydrocarbylene may be on a single carbon atom or on a single heteroatom. Additionally, one of the two valencies or connection points of the diradical may be on a carbon atom and the other valency may be on a different carbon atom; one of the two valencies or connection points may be on a carbon atom and the other on a heteroatom; or one of the two valencies or connection points may be on a heteroatom and the other valency or connection point on a different heteroatom. Each (C₁-C₃₀)heterohydrocarbyl and (C₁-C₃₀)heterohydrocarbylene may be unsubstituted or substituted, aromatic or non-aromatic, saturated or unsaturated, straight chain or branched chain, cyclic (including mono- and poly-cyclic, fused and non-fused polycyclic), or acyclic.

The term “saturated” means lacking carbon-carbon double bonds, carbon-carbon triple bonds, and (in heteroatom-containing groups) carbon-nitrogen, carbon-phosphorous, and carbon-silicon double bonds. Where a saturated chemical group is substituted by one or more substituents R^{S}, one or more double and/or triple bonds optionally may or may not be present in substituents R^{S}. The term “unsaturated” means containing one or more carbon-carbon double bonds, carbon-carbon triple bonds, or (in heteroatom-containing groups) one or more carbon-nitrogen, carbon-phosphorous, or carbon-silicon double bonds, not including double bonds that may be present in substituents R^{S}, if any, or in (hetero) aromatic rings, if any.

The term “linker” means a multivalent group. A linker may connect at least two moieties of a compound together, in particular 2 to 16 moieties of a compound together. For example, a linker that connects two moieties of a compound together is referred to as a divalent linker and a linker that connects three moieties of a compound together is referred to as a trivalent linker.

### Oligomer

The oligomers of the invention include at least one polymerized chromophore monomer unit, as defined herein. The oligomers herein further include at least one polymerized high-T_{g} monomer unit and at least one polymerized low T_{g} monomer unit. The oligomers herein optionally include at least one polymerized additional monomer unit, as defined herein. The oligomers herein may not comprise polymerized monomer units other than the polymerized high-T_{g} monomer units, the polymerized low T_{g} monomer unit, the polymerized chromophore monomer units, and the optional polymerized additional monomer units. The total weight of the polymerized high-T_{g} monomer units, the polymerized low T_{g} monomer unit, the polymerized chromophore monomer units, and the polymerized additional monomer units may represent at least 97%, in particular at least 98%, more particularly at least 99%, more particularly still 100% of the total weight of the oligomer.

In embodiments, the oligomer comprises from 1% to 95% by weight polymerized high-T_{g} monomer units, from 0.1% to 98.9% by weight polymerized low-T_{g} monomer units, from 0.1% to 40% by weight polymerized chromophore monomer units, and from 0 to 20% by weight polymerized additional monomer units, based on the total weight of the oligomer.

In embodiments, the oligomer has formula (I):

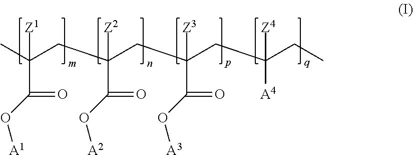

where:
each A¹ is independently (C₁-C₃₀)hydrocarbyl or (C₁-C₃₀)heterohydrocarbyl, preferably (C₁-C₃₀)hydrocarbyl, more preferably at least part of the A¹ moieties is chosen from isobutyl, tert-butyl or a cyclic (C₁-C₃₀)hydrocarbyl;
each A² is independently (C₂-C₃₀)hydrocarbyl or (C₂-C₃₀)heterohydrocarbyl, preferably a (C₄-C₃₀)hydrocarbyl;
each A³ is independently a monovalent residue comprising the Norrish Type II chromophore, preferably a monovalent residue comprising a benzophenone;
each A⁴ is independently a (C₁-C₃₀)hydrocarbyl or (C₁-C₃₀)heterohydrocarbyl, preferably a —(C₁-C₃₀)heterohydrocarbyl bearing a functional group selected from an acidic group, a nitrogen-containing group, a hydroxyl group, an epoxy group, a carbonyl group, an acetoacetoxy group, an acetoacetamide group, a 1,1-dimethyl-3-oxobuyl (diacetone) group, a thiol group, a silane group, an ether bond, an ester bond, and combinations thereof,
Z¹, Z², Z³, and Z⁴ are independently —H or —CH₃;
m is a weight fraction of the polymerized high-T_{g} monomer units;
n is a weight fraction of the polymerized low-T_{g} monomer units;
p is a weight fraction of the polymerized chromophore monomer units;
q is a weight fraction of the at least one polymerized additional monomer units and optionally is zero; and
m+n+p+q is equal to 1.

In an example, in the oligomer according to formula (I), m may be from 0.01 to 0.95; n may be from 0.001 to 0.989, p may be from 0.001 to 0.4, and q may be from 0 to 0.2.

In some embodiments, q is 0, whereby the polymerized additional monomer units are not present in the oligomer.

Further preferential recitations for A¹, A², A³, A⁴ Z¹, Z², Z³, Z⁴, m, n, p and q are defined below for each corresponding monomer unit.

### High-T_{g} Monomer Units

In embodiments, the oligomer includes polymerized high-T_{g} monomer units, which can increase a T_{g} of the oligomer formed therefrom. The high-T_{g} monomer units are distinct from the low-T_{g} monomer units, the chromophore monomer units and the additional monomer units. Accordingly, the high-T_{g} monomer units may not comprise any of the following groups:
a chromophore moiety;
a functional group as defined below for the additional monomer units other than an ether bond.

The polymerized high-T_{g} monomer units may be identical or a combination of multiple types of discrete monomer units such as two types of discrete monomer units, three types of discrete monomer units, four types of discrete monomer units, or more than four types of discrete monomer units. In embodiments, the high-T_{g} monomer units have a glass transition temperature (T_{g}) or a Fox Equation average T_{g} equal to or greater than 25 °C. As defined herein, any reference herein to the T_{g} of a monomer refers to the T_{g} of a homopolymer formed from that monomer. In embodiments where the oligomer comprises two or more distinct high-T_{g} monomer units, such as a combination of methyl (meth)acrylate and isobornyl (meth)acrylate, the T_{g} refers to the Fox Equation average T_{g} of the high-T_{g} monomer units, as defined previously herein. In embodiments, the Fox Equation average T_{g} of the high-T_{g} monomer units is greater than 25 °C, such as equal to or greater than 30 °C, equal to or greater than 35 °C, equal to or greater than 40 °C, equal to or greater than 45 °C, equal to or greater than 50 °C, equal to or greater than 55 °C, equal to or greater than 60 °C, equal to or greater than 65 °C, equal to or greater than 70 °C, equal to or greater than 75 °C, or even equal to or greater than 80 °C. In embodiments, the high T_{g} monomer units may have a T_{g} from 25 °C to 200 °C, from 25 °C to 150 °C, from 25 °C to 130 °C, from 30 °C to 200 °C, from 30 °C to 150 °C, from 30 °C to 130 °C, from 35 °C to 200 °C, from 35 °C to 150 °C, from 35 °C to 130 °C, from 40 °C to 200 °C, from 40 °C to 150 °C, from 40 °C to 130 °C, from 45 °C to 200 °C, from 45 °C to 150 °C, from 45 °C to 130 °C, from 50 °C to 200 °C, from 50 °C to 150 °C, from 50 °C to 130 °C, from 55 °C to 200 °C, from 55 °C to 150 °C, from 55 °C to 130 °C, from 60 °C to 200 °C, from 60 °C to 150 °C, from 60 °C to 130 °C, from 65 °C to 200 °C, from 65 °C to 150 °C, from 65 °C to 130 °C, from 70 °C to 200 °C, from 70 °C to 150 °C, from 70 °C to 130 °C, from 75 °C to 200 °C, from 75 °C to 150 °C, or even from 75 °C to 130 °C, or any and all subranges formed from any of these endpoints.

The Fox Equation average T_{g} of the high-T_{g} monomer units is greater than the Fox Equation average T_{g} of the low-T_{g} monomer units. In embodiments the Fox Equation average T_{g} of the high-T_{g} monomer units is at least 20 °C greater than the Fox Equation average T_{g} of the low-T_{g} monomer units. In embodiments, the difference between the Fox Equation average T_{g} of the high-T_{g} monomer units and the Fox Equation average T_{g} of the low-T_{g} monomer units is greater than 20 °C, such as greater than 25 °C, greater than 30 °C, greater than 35 °C, greater than 40 °C, greater than 45 °C, greater than 50 °C, greater than 55 °C, greater than 60 °C, greater than 65 °C, greater than 70 °C, greater than 75 °C, greater than 80 °C, greater than 85 °C, greater than 90 °C, greater than 95 °C, greater than 100 °C, greater than 105 °C, greater than 110 °C, greater than 115 °C, or greater than 120 °C. In embodiments, the difference between the Fox Equation average T_{g} of the high-T_{g} monomer units and the Fox Equation average T_{g} of the low-T_{g} monomer units is from 20 °C to 200 °C. As non-limiting examples the difference between the Fox Equation average T_{g} of the high-T_{g} monomer units and the Fox Equation average T_{g} of the low-T_{g} monomer units may be from 20 °C to 200 °C, from 20 °C to 150 °C, from 20 °C to 120 °C, from 20 °C to 100 °C, from 20 °C to 90 °C, from 20 °C to 80 °C, from 20 °C to 70 °C, from 20 °C to 60 °C, from 20 °C to 50 °C, from 20 °C to 40 °C, from 20 °C to 30 °C, from 30 °C to 200 °C, from 30 °C to 150 °C, from 30 °C to 120 °C, from 30 °C to 100 °C, from 30 °C to 90 °C, from 30 °C to 80 °C, from 30 °C to 70 °C, from 30 °C to 60 °C, from 30 °C to 50 °C, from 30 °C to 40 °C, from 40 °C to 200 °C, from 40 °C to 150 °C, from 40 °C to 120 °C, from 40 °C to 100 °C, from 40 °C to 90 °C, from 40 °C to 80 °C, from 40 °C to 70 °C, from 40 °C to 60 °C, from 40 °C to 50 °C, from 50 °C to 200 °C, from 50 °C to 150 °C, from 50 °C to 120 °C, from 50 °C to 100 °C, from 50 °C to 90 °C, from 50 °C to 80 °C, from 50 °C to 70 °C, from 50 °C to 60 °C, from 60 °C to 200 °C, from 60 °C to 150 °C, from 60 °C to 120 °C, from 60 °C to 100 °C, from 60 °C to 90 °C, from 60 °C to 80 °C, from 60 °C to 70 °C, from 70 °C to 200 °C, from 70 °C to 150 °C, from 70 °C to 120 °C, from 70 °C to 100 °C, from 70 °C to 90 °C, from 70 °C to 80 °C, from 80 °C to 200 °C, from 80 °C to 150 °C, from 80 °C to 120 °C, from 80 °C to 100 °C, or from 80 °C to 90 °C, or any and all subranges formed from any of these endpoints.

The high T_{g} monomer units consist of one or more (meth)acrylate monomers, preferably one or more monofunctional (meth)acrylate monomers.

In embodiments, the high T_{g} monomer units are monovalent. In other embodiments, the high T_{g} monomer units may be multivalent, where the individual monomer unit comprises two or more active sites that participate in crosslinking upon curing. Examples of monovalent monomer units may include ethyl methacrylate and tert-butyl acrylate.

Examples of multivalent monomer units may include divalent monomer units, such as dicyclopentadienyl diacrylate.

In embodiments, each of the high T_{g} monomer units (prior to being polymerized to form the backbone of the oligomer) may independently be according to formula (II):

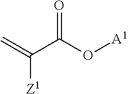

where:
   A¹ is (C₁-C₃₀)hydrocarbyl or (C₁-C₃₀)heterohydrocarbyl, preferably (C₁-C₃₀)hydrocarbyl; and
   Z¹ is —H or —CH₃.

For instance, in embodiments, A¹ is chosen from methyl, ethyl, isopropyl, isobutyl, tert-butyl, a substituted or unsubstituted (C₆-C₁₂)cycloalkyl, or combinations thereof. In embodiments, A¹ is chosen from methyl, tert-butyl, isobornyl, cyclohexyl, or 3,3,5-trimethylcyclohexyl, or combinations thereof.

Preferably, at least part of the high T_{g} monomer units are according to formula (I) wherein Z¹ is —H or —CH₃ and A¹ is chosen from isobutyl, tert-butyl, a substituted or unsubstituted (C₆-C₁₂)cycloalkyl optionally combined with an alkylene moiety, a substituted or unsubstituted (C₆-C₁₂)aryl optionally combined with an alkylene or oxyalkylene moiety, or combinations thereof. More preferably, A¹ is chosen from isobutyl, tert-butyl, isobornyl, cyclohexyl, 3,3,5-trimethylcyclohexyl, tert-butylcyclohexyl, benzyl, adamantyl, dicyclopentanyl, tricyclodecyl, —CH₂-tricyclodecyl, phenyl, —CH₂—CH₂-phenyl, or —CH₂—CH₂—O-phenyl.

When A¹ is isobutyl or cyclohexyl, then Z¹ is CH₃.

Said embodiments equally apply to A¹ in the oligomer of formula (I). Accordingly, at least part of the at least part of the A¹ moieties in the oligomer of formula (I) may be chosen from isobutyl, tert-butyl, a substituted or unsubstituted (C₆-C₁₂)cycloalkyl optionally combined with an alkylene moiety, a substituted or unsubstituted (C₆-C₁₂)aryl optionally combined with an alkylene or oxyalkylene moiety, or combinations thereof. Preferably, at least part of the A¹ moieties in the oligomer of formula (I) is chosen from isobutyl, tert-butyl, isobornyl, cyclohexyl, 3,3,5-trimethylcyclohexyl, tert-butylcyclohexyl, benzyl, adamantyl, dicyclopentanyl, tricyclodecyl, —CH₂-tricyclodecyl, phenyl, —CH₂—CH₂-phenyl, or —CH₂—CH₂—O-phenyl.

Examples of high-T_{g} monomer units in the oligomers herein include but are not limited to monomer units such as 2-phenylethyl methacrylate, 3,3,5-trimethylcyclohexyl acrylate, tert-butyl acrylate, octadecyl methacrylate, octadecyl acrylate, propyl methacrylate, benzyl methacrylate, isobutyl methacrylate, ethyl methacrylate, 2,2,3,3-tetrafluoropropyl methacrylate, 2,2,2-trifluoroethyl methacrylate, isopropyl methacrylate, isobornyl acrylate, methyl methacrylate, isobornyl methacrylate, phenyl methacrylate, tert-butyl methacrylate, cyclohexyl methacrylate, 4-tert-butylcyclohexyl acrylate, 4-tert-butylcyclohexyl methacrylate, 3,3,5-trimethylcyclohexyl acrylate, 3,3,5-trimethylcyclohexyl methacrylate, a substituted or unsubstituted (C₆-C₁₂)cycloalkyl (meth)acrylate, adamantyl (meth)acrylate, dicyclopentanyl (meth)acrylate, tricyclodecane methanol mono(meth)acrylate, 2-phenoxyethyl methacrylate, or combinations thereof.

Preferably, the high T_{g} monomer units of the oligomer comprise a sterically-hindered (meth)acrylate such as isobutyl methacrylate, tert-butyl (meth)acrylate or a cyclic (meth)acrylate. Examples of suitable cyclic (meth)acrylates include phenyl methacrylate, 2-phenylethyl methacrylate, 2-phenoxyethyl methacrylate, isobornyl (meth)acrylate, 3,3,5-trimethylcyclohexyl (meth)acrylate, tert-butylcyclohexyl (meth)acrylate, cyclohexyl methacrylate, benzyl methacrylate, adamantyl (meth)acrylate, dicyclopentanyl (meth)acrylate, tricyclodecane methanol mono(meth)acrylate, and combinations thereof.

Said sterically-hindered (meth)acrylate may optionally be combined with a non-sterically hindered (meth)acrylate such as methyl methacrylate.

The weight fraction of the polymerized high-T_{g} monomer units in the oligomer will vary depending on desired properties of the oligomer, such as T_{g}, molecular weight, and gel content after curing.

As described herein, m of formula (I) is a weight fraction of the polymerized high-T_{g} monomer units in the oligomer. In further embodiments, m is greater than or equal to 0.01, such as greater than or equal to 0.05, greater than or equal to 0.1, greater than or equal to 0.15, greater than or equal to 0.2, greater than or equal to 0.25, greater than or equal to 0.30, greater than or equal to 0.35, greater than or equal to 0.40, greater than or equal to 0.45, greater than or equal to 0.50, greater than or equal to 0.55, or greater than or equal to 0.60. In embodiments, m is from 0.10 to 0.95, from 0.10 to 0.95, from 0.10 to 0.90, from 0.10 to 0.85, from 0.10 to 0.80, from 0.10 to 0.75, from 0.10 to 0.70, from 0.10 to 0.60, from 0.10 to 0.50, from 0.10 to 0.40, from 0.10 to 0.30, from 0.10 to 0.20, from 0.20 to 0.95, from 0.20 to 0.90, from 0.20 to 0.85, from 0.20 to 0.80, from 0.20 to 0.70, from 0.20 to 0.60, from 0.20 to 0.50, from 0.20 to 0.40, from 0.20 to 0.30, from 0.30 to 0.95, from 0.30 to 0.90, from 0.30 to 0.85, from 0.30 to 0.80, from 0.30 to 0.70, from 0.30 to 0.60, from 0.30 to 0.50, from 0.30 to 0.40, from 0.40 to 0.95, from 0.40 to 0.90, from 0.40 to 0.85, from 0.40 to 0.80, from 0.40 to 0.70, from 0.40 to 0.60, from 0.40 to 0.50, from 0.50 to 0.95, from 0.50 to 0.90, from 0.50 to 0.85, from 0.50 to 0.95, from 0.50 to 0.90, from 0.50 to 0.85, from 0.50 to 0.80, from 0.50 to 0.70, from 0.50 to 0.60, from 0.60 to 0.95, from 0.60 to 0.90, from 0.60 to 0.85, from 0.60 to 0.80, from 0.60 to 0.70, from 0.70 to 0.95, from 0.70 to 0.90, from 0.70 to 0.85, or from 0.70 to 0.80.

In a preferred embodiment, m is from 0.20 to 0.90, in particular from 0.25 to 0.85, more particularly from 0.30 to 0.80, even more particularly from 0.35 to 0.75, more particularly yet from 0.40 to 0.75.

It should be understood that, when the oligomer includes more than one discrete type of polymerized high T_{g} monomer unit, the weight fraction m of the polymerized high T_{g} monomer units in the oligomer equals the sum of the individual weight fractions of every discrete type of polymerized high T_{g} monomer unit in the oligomer.

### Low-T_{g} Monomer Units

In embodiments, the oligomer includes polymerized low-T_{g} monomer units. The low T_{g} monomer units are distinct from the high-T_{g} monomer units, the chromophore monomer units and the additional monomer units. Accordingly, the low-T_{g} monomer units may not comprise any of the following groups:
a chromophore moiety;
a functional group as defined below for the additional monomer units.

The polymerized low-T_{g} monomer units may be identical or a combination of multiple types of discrete monomer units such as two types of discrete monomer units, three types of discrete monomer units, four types of discrete monomer units, or more than four types of discrete monomer units. In embodiments, the low-T_{g} monomer units can have a glass transition temperature (T_{g}) less than 25 °C or a Fox Equation average T_{g} less than 25 °C. As defined herein, any reference herein to the T_{g} of a monomer refers to the T_{g} of a homopolymer formed from that monomer. In embodiments where the oligomer comprises two or more distinct low-T_{g} monomer units, the T_{g} refers to the Fox Equation average T_{g} of the low-T_{g} monomer units, as defined previously herein. In embodiments, the low-T_{g} monomer units have a Fox Equation average T_{g} of less than 25 °C, such as less than 20 °C, less than 15 °C, less than 10 °C, less than 5 °C, less than 0 °C, less than −5 °C, less than −10 °C, less than −15 °C, less than −20 °C, or less than −30 °C. In embodiments, the low-T_{g} monomer units have a Fox Equation average T_{g} of from −150 °C to 24 °C, such as preferably −80 °C to 0 °C, and most preferably from −60 °C to −10 °C.

The low T_{g} monomer units consist of one or more (meth)acrylate monomers, preferably one or more monofunctional (meth)acrylate monomers.

In embodiments, the low T_{g} monomer units may be monovalent. In embodiments, the low T_{g} monomer units may include (meth)acrylate monomers, including acrylate monomers and methacrylate monomers. Examples of acrylate monomers include sec-butyl acrylate monomers and n-butyl acrylate monomers. Examples of methacrylate monomers include butyl methacrylate monomers and pentyl methacrylate monomers.

In embodiments, each of the low T_{g} monomer units (prior to being polymerized into the backbone of the oligomer) may independently be according to formula (III):

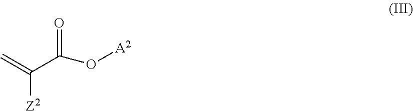

where:
   A² is (C₂-C₃₀)hydrocarbyl or (C₂-C₃₀)heterohydrocarbyl, preferably (C₄-C₃₀)hydrocarbyl; and
   Z² is —H or —CH₃.

In embodiments, A² is a linear or branched (C₂-C₃₀)alkyl preferably a linear or branched (C₄-C₃₀)alkyl. In embodiments, A² is chosen from n-butyl, isobutyl, hexyl, 2-ethylhexyl, isooctyl, isodecyl, tridecyl, lauryl, or combinations thereof.

When A² is isobutyl or cyclohexyl, then Z² is H.

Said embodiments equally apply to A² in the oligomer of formula (I).

Further examples of low T_{g} monomer units of the oligomer include, but are not limited to, monomer units chosen from n-butyl (meth)acrylate, isobutyl acrylate, hexyl (meth)acrylate, 2-ethylhexyl (meth)acrylate, isooctyl (meth)acrylate, isodecyl (meth)acrylate, tridecyl (meth)acrylate, lauryl (meth)acrylate, nonyl acrylate, decyl (meth)acrylate, octyl (meth)acrylate, propyl acrylate, isobutyl acrylate, 2,2,3,3-tetrafluoropropyl acrylate, ethyl acrylate, sec-butyl acrylate, dodecyl acrylate, tetradecyl (meth)acrylate, isopropyl acrylate, pentyl (meth)acrylate, benzyl acrylate, cyclohexyl acrylate, hexadecyl (meth)acrylate, 2-methylbutyl acrylate, 2-octyl acrylate, or combinations thereof.

Preferably, the low T_{g} monomer units of the oligomer are n-butyl acrylate.

The weight fraction of the polymerized low-T_{g} monomer units in the oligomer will vary depending on desired properties of the oligomer, such as T_{g}, molecular weight, and gel content after curing.

As described herein, n of formula (I) is a weight fraction of the polymerized low-T_{g} monomer units in the oligomer. In embodiments, n is greater than or equal to 0.001, such as greater than or equal to 0.02, greater than or equal to 0.05, greater than or equal to 0.10, greater than or equal to 0.15, greater than or equal to 0.20, greater than or equal to 0.25, greater than or equal to 0.30, greater than or equal to 0.35, greater than or equal to 0.40, greater than or equal to 0.45, greater than or equal to 0.50, greater than or equal to 0.55, greater than or equal to 0.60, greater than or equal to 0.65, greater than or equal to 0.70, greater than or equal to 0.75, or greater than or equal to 0.80. In embodiments, n is from 0.001 to 0.989, from 0.001 to 0.90, from 0.001 to 0.80, from 0.001 to 0.70, from 0.001 to 0.60, from 0.001 to 0.50, from 0.001 to 0.40, from 0.001 to 0.30, from 0.001 to 0.20, from 0.001 to 0.10, from 0.001 to 0.05, from 0.01 to 0.989, from 0.01 to 0.90, from 0.01 to 0.80, from 0.01 to 0.70, from 0.01 to 0.60, from 0.01 to 0.50, from 0.01 to 0.40, from 0.01 to 0.30, from 0.01 to 0.20, from 0.01 to 0.10, from 0.01 to 0.05, from 0.05 to 0.989, from 0.05 to 0.90, from 0.05 to 0.80, from 0.05 to 0.70, from 0.05 to 0.60, from 0.05 to 0.50, from 0.05 to 0.40, from 0.05 to 0.30, from 0.05 to 0.20, from 0.05 to 0.10, from 0.10 to 0.989, from 0.10 to 0.90, from 0.10 to 0.80, from 0.10 to 0.70, from 0.10 to 0.60, from 0.10 to 0.50, from 0.10 to 0.40, from 0.10 to 0.30, from 0.10 to 0.20, from 0.20 to 0.989, from 0.20 to 0.90, from 0.20 to 0.80, from 0.20 to 0.70, from 0.20 to 0.60, from 0.20 to 0.50, from 0.20 to 0.40, from 0.20 to 0.30, from 0.30 to 0.989, from 0.30 to 0.90, from 0.30 to 0.80, from 0.30 to 0.70, from 0.30 to 0.60, from 0.30 to 0.50, from 0.30 to 0.40, from 0.40 to 0.989, from 0.40 to 0.90, from 0.40 to 0.80, from 0.40 to 0.70, from 0.40 to 0.60, from 0.40 to 0.50, from 0.50 to 0.989, from 0.50 to 0.90, from 0.50 to 0.80, from 0.50 to 0.70, from 0.50 to 0.60, from 0.60 to 0.989, from 0.60 to 0.90, from 0.60 to 0.80, from 0.60 to 0.70, from 0.70 to 0.989, from 0.70 to 0.90, from 0.70 to 0.80, from 0.80 to 0.989, from 0.80 to 0.90, or from 0.90 to 0.989.

In a preferred embodiment, n is from 0.10 to 0.80, in particular from 0.15 to 0.75, more particularly from 0.20 to 0.70, even more particularly from 0.25 to 0.65, more particularly yet from 0.25 to 0.60.

It should be understood that, when the oligomer includes more than one discrete type of polymerized low T_{g} monomer unit, the weight fraction n of the polymerized low T_{g} monomer units in the oligomer equals the sum of the individual weight fractions of every discrete type of polymerized low T_{g} monomer unit in the oligomer.

The weight ratio of low T_{g} monomer units to high T_{g} monomer units may be adjusted depending on desired properties of the oligomer, such as T_{g} and gel content after curing. In embodiments, the weight ratio of low T_{g} monomer units to high T_{g} monomer units in the oligomer may be from 10:1 to 1:9, from 5:1 to 1:9, from 2:1 to 1:9, from 1:1 to 1:9, from 10:1 to 1:5, from 5:1 to 1:5, from 2:1 to 1:5, from 1:1 to 1:5, from 10:1 to 1:5, or any and all subranges formed from any of these endpoints.

### Chromophore Monomer Units

In addition to at least one polymerized high-T_{g} monomer unit and at least one polymerized low-T_{g} monomer unit, the oligomers further include at least one polymerized chromophore monomer unit. The chromophore monomer units are distinct from the high-T_{g} monomer units, the low-T_{g} monomer units and the additional monomer units.

The polymerized chromophore monomer units may act as a photoinitiator and induce curing of the oligomer upon radiation. A photoinitiator is generally a moiety that, on absorption of light, generates reactive species (ions or radicals) and initiates one or several chemical reactions or transformations.

Photoinitiators may include free-radical photoinitiators. The photoinitiator may be selected so that it is susceptible to activation by photons of the wavelength associated with the actinic radiation (e.g., ultraviolet radiation, visible light) intended to be used to cure a curable composition. Norrish Type II (i.e., non-cleavable) photoinitiator moieties do not break down upon excitation, thus providing fewer possibilities for the leaching of small molecules from the matrix composition. For reference, see e.g. A. Gilbert, J. Baggott: “Essentials of Molecular Photochemistry”, Blackwell, London, 1991). Excited non-cleavable photoinitiators do not break down to radicals upon excitation, but extract a hydrogen atom from an organic molecule or, more efficiently, extract an electron from an electron donor (such as an amine or a thiol). The electron transfer produces a radical anion on the photoinitiator and a radical cation on the electron donor. This is followed by proton transfer from the radical cation to the radical anion to produce two uncharged radicals; of these the radical on the electron donor is sufficiently reactive to abstract a hydrogen atom from most substrates.

The photoinitiator may be a chromophore. Benzophenones and related ketones such as thioxanthones, xanthones, anthraquinones, fluorenones, dibenzosuberones, benzils, and phenyl ketocoumarins are examples of Norrish Type II chromophores. Most amines with a CH bond in an α-position to the nitrogen atom and many thiols are electron donors. Some titanocenes are Norrish Type II chromophores within the scope of the chromophore monomers herein.

In embodiments, the polymerized chromophore monomer units are (meth)acrylate ester monomers having a pendent Norrish Type II chromophore. That is, the Norrish Type II chromophore is not positioned on the terminal ends of the monomers.

Any of the above-discussed Norrish Type II chromophores may be the pendent moiety of the chromophore monomer units of oligomer. In embodiments, the Norrish Type II chromophore is chosen from benzophenones, thioxanthones, or titanocenes. In a specific example, the Norrish Type II chromophore is a benzophenone.

In embodiments, each of the chromophore monomer units (prior to being polymerized into the backbone of the oligomer) may independently be according to formula (IV):

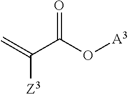

wherein
A³ is a monovalent residue comprising the Norrish Type II chromophore, in particular A³ is X or -L-X;
L is a (C₁-C₁₀)heterohydrocarbylene linker;
X is a monovalent residue of a Norrish Type II chromophore, preferably a monovalent residue of a benzophenone;
Z³ is —H or —CH₃.

In embodiments, A³ of formula (IV) is X or -L-X, where L is a (C₁-C₁₀)heterohydrocarbylene linker and X is a monovalent residue of the Norrish Type II chromophore. As used in this disclosure, the term “residue” shall mean the product of a reactant, such as the moiety remaining from a monomer in a polymer like a portion of a Norrish Type II chromophore. In other embodiments, A³ is a monovalent residue of the Norrish Type II chromophore. In embodiments, X may be a monovalent residue of any one of the above-discussed Norrish Type II chromophores. In embodiments, A³ is a monovalent residue of benzophenone. In embodiments, A³ has formula (IVa):

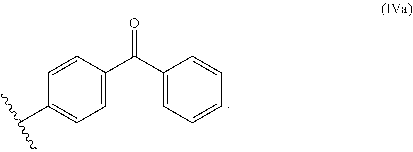 [SMILES: *c1ccc(C(=O)c2ccccc2)cc1]

In embodiments, A³ of formula (IV) is a residue comprising a monovalent radical comprising a moiety chosen from a thioxanthone, an anthraquinone, or a camphorquinone. According to one or more embodiments, A³ is a residue comprising a monovalent radical comprising a thioxanthone.

In particular, A³ of formula (IV) may have the following formula (IVb) or (IVc):

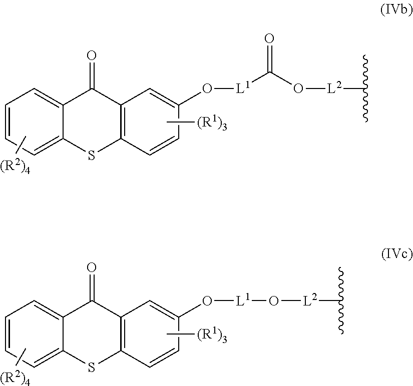

wherein, in formula (IVb) and formula (IVc):
   L¹ is an alkylene;
   L² is a divalent linker comprising at least 2 carbon atoms;
   each R¹ and R² are independently selected from —H, halogen, alkyl, cycloalkyl, heterocycloalkyl, alkoxy, aryloxy, thioalkyl, thioaryl, alkenyl, alkynyl, aryl, aralkyl, alkaryl, heteroaryl, —C(═O)R^{a}, NR^{b}R^{c}, alkylamino, alkylthiol, haloalkyl, —NO₂, —CN, —C(═O)OR^{d}, —C(═O)NR^{b}R^{c};
   R^{a} is selected from an optionally substituted alkyl, an optionally substituted cycloalkyl, an optionally substituted heterocycloalkyl and an optionally substituted aryl; and
   R^{b}, R^{c} and R^{d} are independently selected from —H, alkyl and aryl.

In particular, in formula (IVb) and formula (IVc), R¹ and R² are independently —H, halogen, alkyl or alkoxy. More particularly, R¹ and R² are independently H or alkyl. Even more particularly R¹ and R² are independently H or methyl. More particularly still, R¹ and R² are all —H.

In formula (IVb) and formula (IVc), L¹ is an alkylene. In particular, each L¹ may independently be a linear or branched alkylene having from 1 to 6, from 1 to 4 or from 1 to 2 carbon atoms. More particularly, L¹ is —CH₂— or —CH(CH₃)—. Even more particularly, L¹ is —CH₂—.

In formula (IVb) and formula (IVc), L² is a divalent linker comprising at least 2 carbon atoms. L² may be an aromatic, aliphatic or cycloaliphatic hydrocarbon linker, a polyether linker, a polyester linker, a polycarbonate linker, a polycaprolactone linker, a polyurethane linker, a polyorganosiloxane linker, a polybutadiene linker, and combinations thereof. In particular, L² may be selected from an aromatic, aliphatic or cycloaliphatic hydrocarbon linker, a polyether linker, a polyester linker and combinations thereof.

In formula (IVb) and formula (IVc), L² may be —CH₂—CH(OH)—CH₂— or the residue of a diol. As used herein, the term “residue of a diol” means the linker obtained by removing two OH groups from a diol. Examples of suitable diols include 1,3-propylene glycol, 1,3- or 1,4-butylene glycol, 1,5-pentanediol, 1,6-hexanediol, 1,8-octanediol, 1,9-nonanediol, 1,10-decanediol, 1,12-dodecanediol, 2-methyl-1,3-propanediol, 2,2-diethyl-1,3-propanediol, 3-methyl-1,5-pentanediol, 3,3-dimethyl-1,5-pentanediol, neopentyl glycol, 2,4-diethyl-1,5-pentanediol, cyclohexanediol, cyclohexane-1,4-dimethanol, norbornene dimethanol, norbornane dimethanol, tricyclodecanediol, tricyclodecane dimethanol, bisphenol A, B, F or S, hydrogenated bisphenol A, B, F or S, di-, tri- or tetraethylene glycol, di-, tri- or tetrapropylene glycol, di-, tri- or tetrabutylene glycol, a polyethylene glycol, a polypropylene glycol, a polytetramethylene glycol, a poly(ethylene glycol-co-propylene glycol), a dianhydrohexitol (i.e. isosorbide, isomannide, isoidide), a polybutadiene polyol, a polyester polyol, a polyether polyol, a polyorganosiloxane polyol, a polycarbonate polyol as well as the alkoxylated (e.g., ethoxylated and/or propoxylated) derivatives thereof and the derivatives obtained by ring-opening polymerization of F-caprolactone initiated with one of the aforementioned polyols.

In formula (IVb) and formula (IVc), L² may be —CH₂—CH(OH)—CH₂— or a divalent linker selected from one of formulas (A)-(E):

—(CR²²R′²²)ₐ— (A)

—[(CR²³R′²³)_{b}]_{c}—(CR²³R′²³)_{b}— (B)

—[(CR²⁴R′²⁴)_{d}—O]ₑ—(CR²⁵R′²⁵)_{f}—[O—(CR²⁶R′²⁶)_{d′}]_{e′} (C)

—[(CR²⁷R′²⁷)_{g}—C(═O)O]ₕ—(CR²⁸R′²⁸)ᵢ— or —(CR²⁸R′²⁸)ᵢ—[(CR²⁷R′²⁷)_{g}—C(═O)O]ₕ— (D)

—[(CR²⁹R′²⁹)ⱼ—O—C(═O)—(CR³⁰R′³⁰)ₖ—C(═O)—O]ₗ—(CR²⁹R′²⁹)ⱼ— (E)

wherein
R²², R′²², R²⁵, R′²⁵, R²⁹, R′²⁹, R³⁰ and R′³⁰ are independently H or alkyl;
R²³, R′²³, R²⁴, R′²⁴, R²⁶, R′²⁶, R²⁷, R′²⁷, R²⁸ and R′²⁸ are independently H or methyl;
a is 2 to 20;
b, d, and d′ are independently 2 to 4;
c is 1 to 20;
e and e′ are independently 0 to 20 with the proviso that at least one of q and q′ is not 0;
f is 2 to 20;
g is 3 to 12;
h is 1 to 20;
i is 2 to 8;
j is 2 to 20;
k is 2 to 30;
l is 1 to 20.

In particular, in formula (IVb) and formula (IVc), L² may be —CH₂—CH(OH)—CH₂— or a divalent linker selected from an alkylene such as 1,3-propanediyl, 1,3- or 1,4-butanediyl, 1,5-pentanediyl, 1,6-hexanediyl, 1,8-octanediyl, 1,9-nonanediyl, 1,10-decanediyl, 1,12-decanediyl, 2-methyl-1,3-propanediyl, 2,2-diethyl-1,3-propanediyl, 3-methyl-1,5-pentanediyl, 3,3-dimethyl-1,5-pentanediyl, 2,2-dimethyl-1,3-propanediyl, 2,4-diethyl-1,5-pentanediyl; an alkoxylated (in particular an ethoxylated and/or propoxylated) derivative of the aforementioned alkylenes; an esterified (in particular by ring-opening polymerization of a lactone such as F-caprolactone) derivative of the aforementioned alkylenes; a residue of a di-, tri-, tetra- or polyoxyalkene without the OH groups such as di-, tri- or tetraethylene glycol, di-, tri- or tetrapropylene glycol, di-, tri- or tetrabutylene glycol, polyethylene glycol, polypropylene glycol, polybutylene glycol, poly(ethylene glycol-co-propylene glycol).

In one embodiment, A³ of formula (IV) is according to one of the following formulas (IVd) or (IVe):

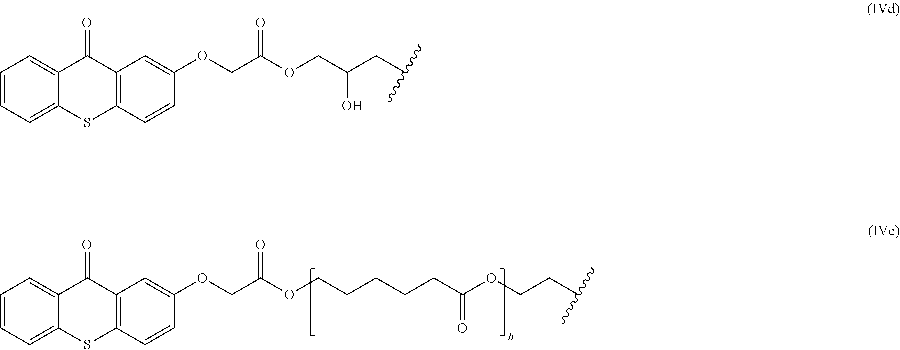

wherein h is 1 to 20.

Other suitable linker groups may be used, including others not including a carbonyl group.

All of the embodiments described above for A³ of formula (IV) equally apply to A³ in the oligomer of formula (I).

The weight fraction of the polymerized chromophore monomer units in the oligomer may be varied based on factors that are known in the art, such as desired cure time among other factors. As described herein, p of formula (I) is a weight fraction of the polymerized chromophore monomer. In embodiments, p is greater than or equal to 0.001, such as greater than or equal to 0.005, or greater than or equal to 0.01. In embodiments, p is from 0.001 to 0.40, from 0.001 to 0.30, from 0.001 to 0.20, from 0.001 to 0.10, from 0.001 to 0.05, from 0.001 to 0.03, from 0.005 to 0.40, from 0.005 to 0.30, from 0.005 to 0.20, from 0.005 to 0.10, from 0.005 to 0.05, from 0.005 to 0.03, or from 0.005 to 0.02.

In a preferred embodiment, p is from 0.005 to 0.30, in particular from 0.005 to 0.20, more particularly from 0.005 to 0.15; even more particularly from 0.005 to 0.10, more particularly yet from 0.01 to 0.10.

It should be understood that, when the oligomer includes more than one discrete type of polymerized chromophore monomer unit, the weight fraction p of the polymerized chromophore monomer units in the oligomer equals the sum of the individual weight fractions of every discrete type of polymerized chromophore monomer unit. Furthermore, it should be understood that, even if a chromophore monomer unit may be characterized based on T_{g} alone as a high T_{g} monomer or a low T_{g} monomer, any monomer including a pendant chromophore is considered to be neither a high T_{g} monomer nor a low T_{g} monomer with respect to calculating the weight fractions m and n in formula (I).

### Additional Monomer Units

The oligomers disclosed herein optionally include at least one polymerized additional monomer unit. The additional monomer units are distinct from the high-T_{g} monomer units, the low-T_{g} monomer units and the chromophore monomer units.

The additional monomer units may comprise a functional group selected from a polymerizable group other than a (meth)acrylate group (i.e. a vinyl group, an allyl group, a conjugated diene group, an alkenyl group), an acidic group (i.e. a carboxylic acid group, a phosphonic acid (—P(═O)(OH)₂) group, a phosphonate (—P(═O)(OR)₂) group, a sulfonic acid (—S(═O)₂₀H) group, a sulfonate (—S(═O)₂₀R) group, a phosphate (—O—P(═O)(OR)₂) group, wherein each R is independently a counterion, a hydrogen atom, or an optionally substituted hydrocarbyl), a nitrogen-containing group (i.e. an amino group, a cyano group or a heterocycle with one or more nitrogen ring atoms), a hydroxyl group, an epoxy group, a carbonyl group, an acetoacetoxy group, an acetoacetamide group, a 1,1-dimethyl-3-oxobuyl (diacetone) group, a thiol group, a silane group, an ether bond, an ester bond (not comprised in a (meth)acrylate group) and combinations thereof.

Preferably, the additional monomer units comprise a functional group selected from an acidic group and a nitrogen-containing group. More preferably, the additional monomer units comprise a functional group selected from a carboxylic acid group, a tertiary amine group, or a heterocycle with one or more nitrogen ring atoms.

It should be highlighted that (meth)acrylic acid corresponds to an additional monomer. Accordingly, the amount by weight of polymerized (meth)acrylic acid units, if present, should be taken into account in the total amount of polymerized additional monomer monomer units and not in the total amount of polymerized high-T_{g} monomer units.

The additional monomer units can include monomer units that are copolymerized with the high-T_{g} monomer units, the low-T_{g} monomer units, and the chromophore monomer units. In embodiments, additional monomer units can include other unsaturated monomer units (other than (meth)acrylic monomer units) such as vinyl amides, vinyl ethers, vinyl esters, vinyl oxazolidinones, (meth)acrylamides, and combinations thereof. In embodiments, the additional monomer units can include other monomer units that are polymerized in the oligomer such as styrene derivatives and maleimides.

In embodiments, the additional monomer units can comprise epoxy, ether, ester, acid, or ketone functionality that are not polymerized in the oligomer. For example, the additional monomer units may comprise a caprolactone-extended acrylate (SR495B, Sartomer), cyclic trimethylolpropane formal acrylate (SR531, Sartomer) propoxylated tetrahydrofurfuryl acrylate (SR611, Sartomer), beta-carboxyethylacrylate, glycidyl methacrylate, or 2-(2-ethoxyethoxy)ethyl acrylate (SR256), neopentyl monomethacrylate, tetrahydrofurfuryl (meth)acrylate, phenoxyethyl acrylate, 2-hydroxypropyl (meth)acrylate, 2-hydroxyethyl (meth)acrylate, 2-cyanobutyl acrylate, 4-cyanobutyl acrylate, 2-cyanoethyl acrylate, cyanomethyl acrylate, and combinations thereof.

In embodiments, the additional monomer units can be or can include a monomer that acts synergistically with the polymerized chromophore monomer units and/or reduce oxygen inhibition. Oxygen inhibition may limit surface curing and hence limit the performances of a resulting cured product.

Common synergist functionality that functions as a synergist for a Type II photoinitiator may include an acidic group, a heterocycle with one or more nitrogen ring atoms, tertiary amine functionality, alkylenoxy functionality (i.e. one or more oxyalkylene units), mercaptan groups, or other sources of readily abstractable hydrogen. Typical addditional monomer units which contain synergist functionality are exemplified by monomers such as (meth)acrylic acid, dimethylaminoethylacrylate (DMAEA), dimethylaminoethylmethacrylate (DMAEMA), diethylaminoethyl acrylate (DEAEA), diethylaminoethyl methacrylate (DEAEMA), N-vinylpyrrolidone (NVP), N-vinylcaprolactam (VCAP), acryloxymorpholine (ACMO), dimethyl acrylamide (DMAC), a poly(ethylenoxide) mono(meth)acrylate, hydroxyethyl ethylene urea (meth)acrylate (HEEU(M)A), the reaction product of a cyclic anhydride with a hydroxy-functional (meth)acrylate, and combinations thereof.

In embodiments, the additional monomer units can comprise an amine synergist. Some examples of amine synergists include tertiary amines. When an amine-synergist containing monomer is included in the oligomer in conjunction with the Norrish Type II chromophore of the polymerized chromophore monomer unit, the tertiary amine provides an active hydrogen donor site for the excited triplet state of the chromophore, thus producing a reactive alkyl-amino radical that subsequently can initiate polymerization. Tertiary amines are also able to convert unreactive peroxy species, formed by reaction between oxygen and free radicals, to reactive alkyl-amino radicals, thus reducing the effects of oxygen on curing.

Examples of amine synergists that may be a component of the polymerized additional monomer include low-molecular weight tertiary amines (i.e. tertiary amines having a molecular weight of less than 200 g/mol) such as triethanol amine, N-methyldiethanol amine. Other types of amine synergists are aminobenzoates, polymerizable aminobenzoates, polymeric aminobenzoates and mixtures thereof. Examples of aminobenzoates include ethyl 4-(dimethylamino)benzoate (EDB), pentyl 4-(dimethylamino)benzoate, 2-ethylhexyl 4-(dimethylamino)benzoate and 2-butoxyethyl 4-(dimethylamino)benzoate (BEDB).

In embodiments, the additional monomer units are (meth)acrylate monomers having a pendent amine functionality.

Any of the above-discussed synergists or amine-based synergists may be the pendent residue in the additional monomer units of the oligomers herein.

In embodiments, each of the additional monomer units (prior to being polymerized into the backbone of the oligomer) may independently be according to formula (V):

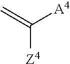

where:
   A⁴ is a (C₁-C₃₀)hydrocarbyl or (C₁-C₃₀)heterohydrocarbyl, preferably a (C₁-C₃₀)heterohydrocarbyl bearing a functional group selected from an acidic group, a nitrogen-containing group, a hydroxyl group, an epoxy group, a carbonyl group, an acetoacetoxy group, an acetoacetamide group, a 1,1-dimethyl-3-oxobuyl (diacetone) group, a thiol group, a silane group, an ether bond, an ester bond, and combinations thereof
   Z⁴ is —H or —CH₃.

A⁴ may comprise a monovalent residue of any one of the above-discussed synergists. In embodiments, Z⁴ is —H or —CH₃ and A⁴ is —C(═O)—O—R⁴ wherein R⁴ is selected from H, dimethylaminomethyl, dimethylaminoethyl, morpholino, dimethylamino, —CH₂—CH₂-imidazolidinone, or combinations thereof. In embodiments, Z⁴ is —H and A⁴ comprises a heterocycle bearing one or more nitrogen ring atoms, for example A⁴ may correspond to one of the following formulae:

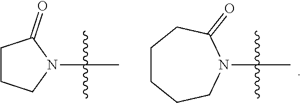 [SMILES: *N1CCCC1=O ; *N1CCCCCC1=O]

Said embodiments equally apply to A⁴ and Z⁴ in the oligomer of formula (I). The weight fraction of the polymerized additional monomer units in the oligomer may be varied depending on factors well-known in the art, such as desired cure time and desired extent of cure. As described herein, q of formula (I) is a weight fraction of the polymerized additional monomer. In embodiments, q is 0. In other embodiments, q is greater than or equal to 0.001, such as greater than or equal to 0.005, or greater than or equal to 0.01. In embodiments, q is from 0.001 to 0.20, from 0.001 to 0.10, from 0.001 to 0.05, from 0.001 to 0.03, from 0.005 to 0.20, from 0.005 to 0.10, from 0.005 to 0.05, from 0.005 to 0.03, or from 0.005 to 0.02.

Preferably, q is from 0 to 0.10.

### Properties of the Oligomer

Oligomers described herein can be formed by polymerization of the different monomer units (i.e. the high-T_{g} monomer units, the low-T_{g} monomer units, the chromophore monomer units, and optionally, the at least one additional monomer unit). Common methods known in the art include, but are not limited, to solution polymerization. Accordingly, the oligomer may be obtained by polymerizing the different monomer units dissolved in a non-reactive solvent in the presence of an initiator. The solution polymerization may be conducted at a temperature of at least 50 °C, preferably at least 60 °C. Examples of suitable non-reactive solvents include toluene, heptane, ethyl acetate, methyl ethyl ketone (MEK), isopropanol and combinations thereof. The initiator may be a thermal initiator. Thermal initiators are well known in the art and include, for example, peroxides (i.e., a compound comprising an oxygen-oxygen single bond), especially inorganic persulfate compounds such as ammonium persulfate, potassium persulfate and sodium persulfate; hydrogen peroxide; organic peroxides such as cumene hydroperoxide, t-butyl hydroperoxide, acetyl peroxide, benzoyl peroxide, lauroyl peroxide; peracids such as peracetic acid and perbenzoic acid; redox initiators wherein a reducing agent such as a ferrous compound promotes the decomposition of a peroxide; as well as other free radical producing materials such as an azo-initiator (i.e., a compound comprising an nitrogen-nitrogen double bond), for example 2,2′-azobisisobutyronitrile, 4,4′-azobis(4-cyanovaleric acid) or 2,2′-azobis(2-methylbutyronitrile); and combinations thereof. The initiator may be added in an amount such that the total monomer:initiator weight ratio is from 100:1 to 1000:1 The solution polymerization typically provides a mixture of the oligomer dissolved in the non-reactive solvent. The non-reactive solvent may be eliminated by heating. A reactive diluent may be added prior to the elimination of the non-reactive solvent to form a curable composition as detailed below At the end of the solution polymerization (i.e. prior to the introduction of the reactive diluent) the mixture may have a solids content of from 25% to 70%, preferably from 30% to 50%, by weight based on the total weight of the mixture. Said mixture may have a residual amount of monomers that is less than 2%, in particular less than 1%, more particularly less than 0.5%, by weight based on the total weight of the mixture. The experimental parameters of the solution polymerization (i.e. solids content, reaction temperature, reaction time and total monomer:initiator ratio) can be adjusted to produce oligomers of relatively low molecular weights using experimental conditions well known by those skilled in the art.

Preferably, the oligomer is not obtained by telomerization, i.e. in the presence of a telogen compound (i.e. a compound bearing at least one cleavable bond selected from C—H, S—H, P—H, Si—H or C—X, where X=Cl, Br or I) such as tetrabromomethane (CBr₄), bromotrichloromethane (CBrCl₃), dibromodichloromethane (CBr₂Cl₂), a mercaptan, hydrogen disulfide.

In embodiments, the oligomer may have a weight average molecular weight of at least 10,000 grams per mole (g/mol). In embodiments, the oligomer may have a weight average molecular weight from 10,000 g/mol to 600,000 g/mol. In embodiments, the oligomer may have a weight average molecular weight equal to or greater than 10,000 g/mol, equal to or greater than 25,000 g/mol, or even equal to or greater than 50,000 g/mol. In embodiments, the oligomer may have a weight average molecular weight equal to or less than 600,000 g/mol, equal to or less than 500,000 g/mol, equal to or less than 400,000 g/mol, equal to or less than 300,000 g/mol, equal to or less than 200,000 g/mol, or even equal to or less than 100,000 g/mol. In embodiments, the oligomer may have a weight average molecular weight from 10,000 g/mol to 600,000 g/mol, from 10,000 g/mol to 500,000 g/mol, from 10,000 g/mol to 400,000 g/mol, from 10,000 g/mol to 300,000 g/mol, from 10,000 g/mol to 200,000 g/mol, from 10,000 g/mol to 100,000 g/mol, from 25,000 g/mol to 600,000 g/mol, from 25,000 g/mol to 500,000 g/mol, from 25,000 g/mol to 400,000 g/mol, from 25,000 g/mol to 300,000 g/mol, from 25,000 g/mol to 200,000 g/mol, from 25,000 g/mol to 100,000 g/mol, from 50,000 g/mol to 600,000 g/mol, from 50,000 g/mol to 500,000 g/mol, from 50,000 g/mol to 400,000 g/mol, from 50,000 g/mol to 300,000 g/mol, from 50,000 g/mol to 200,000 g/mol, or even from 50,000 g/mol to 100,000 g/mol, or any and all subranges formed from any of these endpoints.

In a preferred embodiment, the oligomer may have a weight average molecular weight of from 10,000 g/mol to 100,000 g/mol, in particular from 10,000 g/mol to 90,000 g/mol, in particular from 11,000 g/mol to 80,000 g/mol, more particularly from 12,000 g/mol to 75,000 g/mol, even more particularly from 15,000 g/mol to 70,000 g/mol, more particularly still from 15,000 g/mol to 65,000 g/mol.

Number average molecular weight and weight average molecular weight reported herein are determined using a size exclusion chromatography (SEC) using poly(methyl methacrylate) reference standards and tetrahydrofuran as the solvent, unless expressly noted otherwise.

In embodiments, the oligomer can have a T_{g} of equal to or greater than 0 °C, such as equal to or greater than 5 °C, equal to or greater than 10 °C, equal to or greater than 15 °C, equal to or greater than 20 °C, equal to or greater than 25 °C, equal to or greater than 30 °C, equal to or greater than 35 °C, equal to or greater than 40 °C, equal to or greater than 45 °C, or equal to or greater than 50 °C. In embodiments, the oligomer can have a T_{g} of from 0 °C to 100 °C, such as from 0 °C to 90 °C, from 0 °C to 80 °C, from 0 °C to 70 °C, from 0 °C to 60 °C, from 0 °C to 50 °C, from 10 °C to 100 °C, from 10 °C to 90 °C, from 10 °C to 80 °C, from 10 °C to 70 °C, from 10 °C to 60 °C, from 10 °C to 50 °C, from 20 °C to 100 °C, from 20 °C to 90 °C, from 20 °C to 80 °C, from 20 °C to 70 °C, from 20 °C to 60 °C, or from 20 °C to 50 °C.

Preferably, the oligomer has a T_{g} of from 20 °C to 100 °C, more particularly from 30 to 100 °C.

In embodiments, the oligomer can have a gel content of at least 10%, as measured by the method, “Method A—Gel Content”, disclosed herein. For instance, the oligomer can have a gel content of at least 10%, at least 15%, at least 20%, at least 25%, at least 30%, at least 35%, at least 40%, at least 45%, at least 50%, at least 55%, or even at least 60%. In this context, the gel content is measured based on the neat oligomer (i.e., with no other compounds, such as diluents).

In a preferred embodiment, the oligomer may have formula (V):

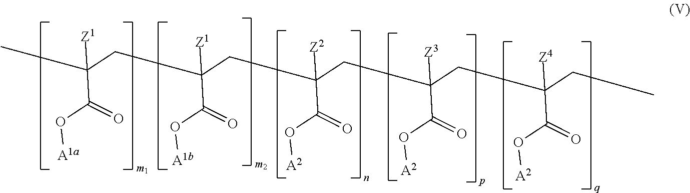

wherein:
   each A^{1a} is independently chosen from isobutyl, tert-butyl or a cyclic (C₁-C₃₀)hydrocarbyl;
   each A^{1b} is independently chosen from a (C₁-C₃₀)hydrocarbyl other than isobutyl, tert-butyl or a cyclic (C₁-C₃₀)hydrocarbyl;
   each A² is independently (C₂-C₃₀)hydrocarbyl or (C₂-C₃₀)heterohydrocarbyl;
   each A³ is independently a monovalent residue comprising the Norrish Type II chromophore, preferably a monovalent residue comprising a benzophenone;
   each A⁴ is independently a (C₁-C₃₀)hydrocarbyl or (C₁-C₃₀)heterohydrocarbyl, preferably a —(C₁-C₃₀)heterohydrocarbyl bearing a functional group selected from an acidic group, a nitrogen-containing group, a hydroxyl group, an epoxy group, a carbonyl group, an acetoacetoxy group, an acetoacetamide group, a 1,1-dimethyl-3-oxobuyl (diacetone) group, a thiol group, a silane group, an ether bond, an ester bond, and combinations thereof,
   Z¹, Z², Z³, and Z⁴ are independently —H or —CH₃;
   m₁ is 0.01 to 0.95, in particular from 0.20 to 0.90, more particularly from 0.25 to 0.85, even more particularly from 0.30 to 0.80, more particularly yet from 0.35 to 0.75, more particularly still from 0.40 to 0.75;
   m₂ is 0 to 0.94, in particular from 0 to 0.90, more particularly from 0 to 0.80, even more particularly from 0 to 0.70, more particularly yet from 0 to 0.60, more particularly still from 0 to 0.50;
   n is 0.001 to 0.989, in particular from 0.10 to 0.80, more particularly from 0.15 to 0.75, even more particularly from 0.20 to 0.70, more particularly yet from 0.25 to 0.65, more particularly still from 0.25 to 0.60;
   p is 0.001 to 0.40, in particular from 0.005 to 0.30, more particularly from 0.005 to 0.20, even more particularly from 0.005 to 0.15; more particularly yet from 0.005 to 0.10, more particularly still from 0.01 to 0.10;
   q is 0 to 0.20, in particular from 0 to 0.10; and
   m₁+m₂+n+p+q is equal to 1;
   m₁+m₂ is from 0.01 to 0.95, in particular 0.20 to 0.90, more particularly from 0.25 to 0.85, even more particularly from 0.30 to 0.80, more particularly yet from 0.35 to 0.75, more particularly still from 0.40 to 0.75.

As a non-limiting example, the oligomer may have formula (V):

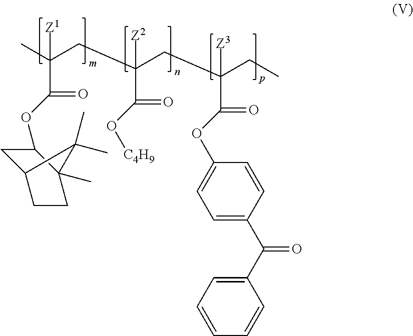

where m is from 0.2 to 0.8, n is from 0.1 to 0.8, and p is from 0.001 to 0.2.

In embodiments Z¹, Z², and Z³ of formula (V) are independently —H or —CH₃. For instance, in embodiments, Z¹ is —CH₃ and both Z² and Z³ are —H.

### Curable Composition

In embodiments, a curable composition, preferably an ultraviolet curable composition, can comprise at least one of the oligomers described herein. In embodiments, the ultraviolet curable composition may not include any additional photoinitiators, other than the polymerized chromophore monomer units of the oligomer. That is, in embodiments, the oligomer can be cured upon irradiation without any additional photoinitiators. In other embodiments, the curable composition can comprise one or more photoinitiators in addition to the polymerized chromophore monomer units of the oligomer. In a preferred embodiment, the curable composition may be substantially free of a photoinitiator other than the oligomer of the present invention. In particular, the curable composition may comprise less than 0.1%, in particular less than 0.05%, more particularly less than 0.001%, even more particularly 0% by weight of photoinitiator other than the oligomer of the present invention.

Preferably, the curable composition does not comprise a (meth)acrylic copolymer having a T_{g} of less than 0 °C. More preferably, the curable composition does not comprise a (meth)acrylic copolymer other than the oligomer of the invention.

In embodiments, the curable composition can comprise one or more (meth)acrylate monomers or oligomers, diluents, (meth)acrylate oligomers, fillers, photoinitiators, slip agents, thickeners, slip agents, hindered amine light stabilizers, ultraviolet absorbing monomers, or other auxiliary additives. In embodiments, at least one (meth)acrylate oligomer is included in the curable composition and is chosen from at least one of urethane acrylate and urethane methacrylate, and at least one (meth)acrylate monomer is included and is chosen from at least one of 2-hydroxyethyl methacrylate and isobornyl methacrylate.

In a preferred embodiment, the curable composition comprises the oligomer according to the invention and a reactive diluent. The reactive diluent may be used with or completely replace a non-reactive solvent used to prepare the oligomer.

In embodiments, the reactive diluent may have a viscosity equal to or less than 3000 cP, as measured by Brookfield DV-III viscometer using Spindle SC-27 at 25 °C, such as equal to or less than 2750 cP, equal to or less than 2500 cP, equal to or less than 2250 cP, equal to or less than 2000 cP, equal to or less than 1750 cP, equal to or less than 1500 cP, or even equal to or less than 1250. In embodiments, the reactive diluent may have a viscosity equal to or greater than 5 cP, as measured by Brookfield DV-III viscometer using Spindle SC-27 at 25 °C, such as equal to or greater than 25 cP, equal to or greater than 50 cP, equal to or greater than 100 cP, equal to or greater than 250 cP, equal to or greater than 500 cP, equal to or greater than 750 cP, or even equal to or greater than 1000 cP. In embodiments, the reactive diluent may have a viscosity, as measured by Brookfield DV-III viscometer using Spindle SC-27 at 25 °C, from 25 cP to 3000 cP, from 25 cP to 2750 cP, from 25 cP to 2500 cP, from 25 cP to 2250 cP, from 25 cP to 2000 cP, from 25 cP to 1750 cP, from 25 cP to 1500 cP, from 25 cP to 1250 cP, from 25 cP to 3000 cP, from 25 cP to 2750 cP, from 25 cP to 2500 cP, from 25 cP to 2250 cP, from 25 cP to 2000 cP, from 25 cP to 1750 cP, from 25 cP to 1500 cP, from 25 cP to 1250 cP, from 50 cP to 3000 cP, from 50 cP to 2750 cP, from 50 cP to 2500 cP, from 50 cP to 2250 cP, from 50 cP to 2000 cP, from 50 cP to 1750 cP, from 50 cP to 1500 cP, from 50 cP to 1250 cP, from 100 cP to 3000 cP, from 100 cP to 2750 cP, from 100 cP to 2500 cP, from 100 cP to 2250 cP, from 100 cP to 2000 cP, from 100 cP to 1750 cP, from 100 cP to 1500 cP, from 100 cP to 1250 cP, from 250 cP to 3000 cP, from 250 cP to 2750 cP, from 250 cP to 2500 cP, from 250 cP to 2250 cP, from 250 cP to 2000 cP, from 250 cP to 1750 cP, from 250 cP to 1500 cP, from 250 cP to 1250 cP, from 500 cP to 3000 cP, from 500 cP to 2750 cP, from 500 cP to 2500 cP, from 500 cP to 2250 cP, from 500 cP to 2000 cP, from 500 cP to 1750 cP, from 500 cP to 1500 cP, from 500 cP to 1250 cP, from 750 cP to 3000 cP, from 750 cP to 2750 cP, from 750 cP to 2500 cP, from 750 cP to 2250 cP, from 750 cP to 2000 cP, from 750 cP to 1750 cP, from 750 cP to 1500 cP, from 750 cP to 1250 cP, from 1000 cP to 3000 cP, from 1000 cP to 2750 cP, from 1000 cP to 2500 cP, from 1000 cP to 2250 cP, from 1000 cP to 2000 cP, from 1000 cP to 1750 cP, from 1000 cP to 1500 cP, or even from 1000 cP to 1250 cP, or any and all subranges formed from any of these endpoints.

The reactive diluent may comprise at least one radically polymerizable diluent. The reactive diluent may comprise a mixture of radically polymerizable diluents. When the reactive diluent comprises a mixture of radically polymerizable diluents, the embodiment relating to the viscosity applies to the mixture of the radically polymerizable diluents.

As used herein, a radically polymerizable diluent is a compound having at least one polymerizable carbon-carbon double bond and preferably a suitable viscosity as defined above. A polymerizable carbon-carbon double bond is capable of participating in a free radical polymerization wherein at least one of the carbon atoms of the double bond becomes covalently bonded to another atom, in particular a carbon atom, in a second molecule. In particular, the reactive diluent may comprise at least one radically polymerizable diluent selected from a (meth)acrylate, a vinyl ether, a vinyl amide, a vinyl oxazolidinone, and combinations thereof. These diluents can be monofunctional (i.e. bear a single polymerizable carbon-carbon double bond) or multifunctional (i.e. bear at least two polymerizable carbon-carbon double bonds). These diluents can be selected to provide targeted final properties of the cured formulations as long as they provide adequate viscosity reduction of the oligomer while also producing adequate properties when curable composition is cured.

The reactive diluent may comprise a monofunctional (meth)acrylate (i.e. a monomer bearing a single (meth)acrylate group). Examples of suitable monofunctional (meth)acrylates include mono-(meth)acrylate esters of aliphatic alcohols (wherein the aliphatic alcohol may be straight chain, branched or alicyclic and may be a mono-alcohol, a di-alcohol or a polyalcohol, provided only one hydroxyl group is esterified with (meth)acrylic acid); mono-(meth)acrylate esters of aromatic alcohols (such as phenols, including alkylated phenols); mono-(meth)acrylate esters of alkylaryl alcohols (such as benzyl alcohol); mono-(meth)acrylate esters of oligomeric and polymeric glycols such as diethylene glycol, triethylene glycol, dipropylene glycol, tripropylene glycol, polyethylene glycol, and polypropylene glycol); mono-(meth)acrylate esters of monoalkyl ethers of glycols and oligoglycols; mono-(meth)acrylate esters of alkoxylated (e.g., ethoxylated and/or propoxylated) aliphatic alcohols (wherein the aliphatic alcohol may be straight chain, branched or alicyclic and may be a mono-alcohol, a di-alcohol or a polyalcohol, provided only one hydroxyl group of the alkoxylated aliphatic alcohol is esterified with (meth)acrylic acid); mono-(meth)acrylate esters of alkoxylated (e.g., ethoxylated and/or propoxylated) aromatic alcohols (such as alkoxylated phenols); caprolactone mono(meth)acrylates; and the like. The following compounds are specific examples of mono(meth)acrylate-functionalized monomers suitable for use: methyl (meth)acrylate; ethyl (meth)acrylate; n-propyl (meth)acrylate; n-butyl (meth)acrylate; isobutyl (meth)acrylate; n-hexyl (meth)acrylate; 2-ethylhexyl (meth)acrylate; n-octyl (meth)acrylate; isooctyl (meth)acrylate; n-decyl (meth)acrylate; n-dodecyl (meth)acrylate; tridecyl (meth)acrylate; tetradecyl (meth)acrylate; hexadecyl (meth)acrylate; 2-hydroxyethyl (meth)acrylate; 2- and 3-hydroxypropyl (meth)acrylate; 2-methoxyethyl (meth)acrylate; 2-ethoxyethyl (meth)acrylate; 2- and 3-ethoxypropyl (meth)acrylate; tetrahydrofurfuryl (meth)acrylate; alkoxylated tetrahydrofurfuryl (meth)acrylate; 2-(2-ethoxyethoxy)ethyl (meth)acrylate; cyclohexyl (meth)acrylate; glycidyl (meth)acrylate; isodecyl (meth)acrylate; lauryl (meth)acrylate; 2-phenoxyethyl (meth)acrylate; alkoxylated phenol (meth)acrylates; alkoxylated nonylphenol (meth)acrylates; cyclic trimethylolpropane formal (meth)acrylate; isobornyl (meth)acrylate; tricyclodecanemethanol (meth)acrylate; tert-butylcyclohexanol (meth)acrylate; trimethylcyclohexanol (meth)acrylate; diethylene glycol monomethyl ether (meth)acrylate; diethylene glycol monoethyl ether (meth)acrylate; diethylene glycol monobutyl ether (meth)acrylate; triethylene glycol monoethyl ether (meth)acrylate; ethoxylated lauryl (meth)acrylate; methoxy polyethylene glycol (meth)acrylates; hydroxyl ethyl-butyl urethane (meth)acrylates; 3-(2-hydroxyalkyl)oxazolidinone (meth)acrylates; and combinations thereof.

The reactive diluent may comprise a monofunctional (meth)acrylate bearing one or more of the following groups: a ring or ring system (i.e. one or more rings selected from aromatic rings and/or (hetero)cycloaliphatic rings which may be fused and/or bridged), a C₇-C₂₀ hydrocarbon chain (i.e. a linear or branched chain bearing only carbon and hydrogen atoms wherein the number of carbon atoms in the chain is from 7 to 20), one or more oxyalkylene units (such as oxyethylene, oxypropylene and/or oxybutylene units), one or more ester units derived from the ring-opening of a lactone (such as F-caprolactone) and combinations thereof. Examples of such monofunctional (meth)acrylates are isobornyl (meth)acrylate, tetrahydrofurfuryl (meth)acrylate, phenol (meth)acrylate, nonylphenol (meth)acrylate, octyl (meth)acrylate, isooctyl (meth)acrylate, 2-ethylhexyl (meth)acrylate, decyl (meth)acrylate, isodecyl (meth)acrylate; lauryl (meth)acrylate; tridecyl (meth)acrylate, stearyl (meth)acrylate, a (poly)caprolactone mono(meth)acrylate, di-, tri-, tetra- or polyethylene glycol mono(meth)acrylate, di-, tri-, tetra- or polyethylene glycol monomethyl ether (meth)acrylate, di-, tri-, tetra- or polyethylene glycol monoethyl ether (meth)acrylate, as well as the alkoxylated (i.e. ethoxylated and/or propoxylated) derivatives thereof, and combinations thereof.

The reactive diluent may comprise a monofunctional (meth)acrylate monomer having a Tg that is higher than 25 °C, preferably higher than 30 °C, more preferably higher than 35 °C, even more preferably higher than 40 °C, more preferably still higher than 45 °C, more preferably yet higher than 50 °C. Examples of such monomers include 2-phenylethyl methacrylate, neopentyl methacrylate, 3,3,5-trimethylcyclohexyl acrylate, tert-butyl acrylate, octadecyl methacrylate, octadecyl acrylate, glycidyl methacrylate, propyl methacrylate, tetrahydrofurfuryl methacrylate, benzyl methacrylate, isobutyl methacrylate, glycidyl methacrylate, ethyl methacrylate, 2,2,3,3-tetrafluoropropyl methacrylate, 2-hydroxypropyl methacrylate, 2,2,2-trifluoroethyl methacrylate, 2-hydroxyethyl methacrylate, isopropyl methacrylate, isobornyl acrylate, methyl methacrylate, butyl cyanoacrylate, isobornyl methacrylate, phenyl methacrylate, 2-cyanobutyl acrylate, tert-butyl methacrylate, cyclohexyl acrylate, cyclohexyl methacrylate, 4-tert-butylcyclohexyl acrylate, 4-tert-butylcyclohexyl methacrylate, ethyl cyanoacrylate, methyl cyanoacrylate, 3,3,5-trimethylcyclohexyl acrylate, 3,3,5-trimethylcyclohexyl methacrylate, a substituted or unsubstituted (C₆-C₁₂)cycloalkyl (meth)acrylate, adamantyl (meth)acrylate, dicyclopentanyl (meth)acrylate, tricyclodecane methanol mono(meth)acrylate, 2-phenoxyethyl methacrylate, or combinations thereof.

The reactive diluent may comprise a polyfunctional (meth)acrylate (i.e. a monomer bearing at least two (meth)acrylate groups), such as bisphenol A di(meth)acrylate; hydrogenated bisphenol A di(meth)acrylate; ethylene glycol di(meth)acrylate; diethylene glycol di(meth)acrylate; triethylene glycol di(meth)acrylate; tetraethylene glycol di(meth)acrylate; polyethylene glycol di(meth)acrylate; propylene glycol di(meth)acrylate; dipropylene glycol di(meth)acrylate; tripropylene glycol di(meth)acrylate; tetrapropylene glycol di(meth)acrylate; polypropylene glycol di(meth)acrylate; polytetramethylene glycol di(meth)acrylate; 1,2-butanediol di(meth)acrylate; 2,3-butanediol di(meth)acrylate; 1,3-butanediol di(meth)acrylate; 1,4-butanediol di(meth)acrylate; 1,5-pentanediol di(meth)acrylate; 1,6-hexanediol di(meth)acrylate; 1,8-octanediol di(meth)acrylate; 1,9-nonanediol di(meth)acrylate; 1,10-nonanediol di(meth)acrylate; 1,12-dodecanediol di(meth)acrylate; neopentyl glycol di(meth)acrylate; 2-methyl-2,4-pentanediol di(meth)acrylate; polybutadiene di(meth)acrylate; cyclohexane-1,4-dimethanol di(meth)acrylate; tricyclodecane dimethanol di(meth)acrylate; metallic di(meth)acrylates; modified metallic di(meth)acrylates; glyceryl di(meth)acrylate; glyceryl tri(meth)acrylate; trimethylolethane tri(meth)acrylate; trimethylolethane di(meth)acrylate; trimethylolpropane tri(meth)acrylate; trimethylolpropane di(meth)acrylate; pentaerythritol di(meth)acrylate; pentaerythritol tri(meth)acrylate; pentaerythritol tetra(meth)acrylate, di(trimethylolpropane) diacrylate; di(trimethylolpropane) triacrylate; di(trimethylolpropane) tetraacrylate, sorbitol penta(meth)acrylate; di(pentaerythritol) tetraacrylate; di(pentaerythritol) pentaacrylate; di(pentaerythritol) hexa(meth)acrylate; tris (2-hydroxyethyl) isocyanurate tri(meth)acrylate; as well as the alkoxylated (e.g., ethoxylated and/or propoxylated) derivatives thereof, and combinations thereof.

The reactive diluent may comprise a vinyl ether such as dodecyl vinyl ether, hydroxybutyl vinyl ether, cyclohexanedimethylol divinyl ether, and DVE-3 (triethylene glycol divinyl ether) and combinations thereof.

The reactive diluent may comprise a vinyl amide such as N-vinylpyrrolidone (NVP), N-vinyl caprolactam (V-CAP) and combinations thereof.

The reactive diluent may comprise a vinyl oxazolidinone such as vinyl methyl oxazolidinone (VMOX).

In a preferred embodiment the reactive diluent preferably comprises a monofunctional (meth)acrylate, a polyfunctional (meth)acrylate or a mixture of a monofunctional (meth)acrylate and a polyfunctional (meth)acrylate.

The amount of reactive diluent in the curable composition will vary depending on the desired viscosity. In embodiments, the curable composition may comprise, based on a weight of the curable composition, from 20% to 80% by weight of the reactive diluent. In embodiments, the curable composition may comprise, based on a weight of the curable composition, equal to or greater than 20%, equal to or greater than 25%, equal to or greater than 30%, equal to or greater than 35%, or even equal to or greater than 40%, by weight of the reactive diluent. In embodiments, the curable composition may comprise, based on a weight of the curable composition, equal to or less than 80%, equal to or less than 75%, equal to or less than 70%, equal to or less than 65%, or even equal to or less than 60%, by weight of the reactive diluent. In embodiments, the amount by weight of the reactive diluent in the curable composition, based on the total weight of the curable composition, may be from 20% to 80%, from 20% to 75%, from 20% to 70%, from 20% to 75%, from 20% to 60%, from 25% to 80%, from 20% to 75%, from 25% to 70%, from 25% to 75%, from 25% to 60%, from 30% to 80%, from 30% to 75%, from 30% to 70%, from 30% to 75%, from 30% to 60%, from 35% to 80%, from 35% to 75%, from 35% to 70%, from 35% to 75%, from 35% to 60%, from 40% to 80%, from 40% to 75%, from 40% to 70%, from 40% to 75%, or even from 40% to 60%, or any and all subranges formed from any of these endpoints.

In a preferred embodiment the curable composition, may comprise at least 5%, at least 10%, at least 15%, at least 20%, at least 30%, at least 40% or at least 50% by weight of a monofunctional (meth)acrylate monomer as defined above, based on the total weight of the curable composition. Alternatively, the curable composition, may comprise less than 5%, less than 4%, less than 3%, less than 2%, less than 1% or even 0% by weight of a monofunctional (meth)acrylate monomer as defined above, based on the total weight of the curable composition.

In a preferred embodiment the curable composition, may comprise at least 5%, at least 10%, at least 15%, at least 20%, at least 30%, at least 40% or at least 50% by weight of a polyfunctional (meth)acrylate monomer as defined above, based on the total weight of the curable composition. Alternatively, the curable composition, may comprise less than 5%, less than 4%, less than 3%, less than 2%, less than 1% or even 0% by weight of a polyfunctional (meth)acrylate monomer as defined above, based on the total weight of the curable composition.

In embodiments, a weight ratio of the oligomer to the reactive diluent in the curable composition may be from 4:1 to 1:4, such as from 3:1 to 1:4, from 2:1 to 1:4, from 1:1 to 1:4, from 3:1 to 1:3, from 2:1 to 1:3, from 1:1 to 1:3, from 3:1 to 1:2, from 2:1 to 1:2, from 1:1 to 1:2, from 3:1 to 1:1, or even from 2:1 to 1:1, or any and all subranges formed from any of these endpoints.

In a preferred embodiment, the curable composition comprises the oligomer according to the invention and a (meth)acrylate-functionalized oligomer.

A (meth)acrylate-functionalized oligomer may be selected in order to enhance the flexibility, strength and/or modulus, among other attributes, of a cured polymer prepared by curing the curable composition of the invention.

A (meth)acrylate functionalized oligomer may have 1 to 18 (meth)acrylate groups, in particular 2 to 6 (meth)acrylate groups, more particularly 2 to 6 acrylate groups.

A (meth)acrylate functionalized oligomer may have a number average molecular weight equal or more than 600 g/mol, in particular 800 to 15,000 g/mol, more particularly 1,000 to 5,000 g/mol.

In particular, the curable composition may comprise a (meth)acrylate-functionalized oligomer selected from the group consisting of epoxy (meth)acrylates, polyester (meth)acrylates, polyether (meth)acrylates, urethane (meth)acrylates, (meth)acrylated poly(meth)acrylates and mixtures thereof.

Non-limiting examples of epoxy (meth)acrylates are the reaction products of an epoxide (such as glycidyl ethers, glycidyl esters, cycloaliphatic epoxides or epoxides obtained by epoxidation of mono- and/or polyunsaturated compounds) with a (meth)acrylating agent (such as (meth)acrylic acid, (meth)acrylic anhydride, (meth)acryloyl chloride or combinations thereof). The epoxide may be an epoxide EPOX selected from 1,2,3,4-diepoxybutane; 1,2,4,5-diepoxypentane; 1,2,5,6-diepoxyhexane; 1,2,7,8-diepoxyoctane; 1,2,9,10-diepoxydecane; bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolak resin, hydrogenated bisphenol A diglycidyl ether, hydrogenated bisphenol F diglycidyl ether, hydrogenated bisphenol S diglycidyl ether, 3,4-epoxycyclohexylmethyl-3′,4′-epoxycyclohexanecarboxylate, 2-(3,4-epoxycyclohexyl-5,5-spiro-3,4-epoxy)cyclohexane-1,4-dioxane, bis(3,4-epoxycyclohexylmethyl)adipate, vinylcyclohexene oxide, 4-vinylepoxycyclohexane, bis(3,4-epoxy-6-methylcyclohexylmethyl)adipate,3,4-epoxy-6-methylcyclohexyl-3′,4′-epoxy-6′-methylcyclohexanecarboxylate, methylenebis(3,4-epoxycyclohexane), dicyclopentadiene diepoxide, di(3,4-epoxycyclohexylmethyl) ether of ethylene glycol, ethylenebis(3, 4-epoxycyclohexanecarboxylate), ethylene glycol diglycidyl ether, 1,2- or 1,3-propylene glycol diglycidyl ether, 1,2-, 1,3- or 1,4-butanediol diglycidyl ether, 1,5-pentanediol diglycidyl ether, 1,6-hexanediol diglycidyl ether, 1,7-hexanediol diglycidyl ether, 1,8-octanediol diglycidyl ether, 1,9-nonanediol diglycidyl ether, 1,10-decanediol diglycidyl ether, 1,12-dodecanediol diglycidyl ether, 2-methyl-1,3-propanediol diglycidyl ether, neopentyl glycol diglycidyl ether, 2,2-diethyl-1,3-propane diol diglycidyl ether, 3-methyl-1,5-pentanediol diglycidyl ether, 3,3-dimethyl-1,5-pentanediol diglycidyl ether, 2,4-diethyl-1,5-pentanediol diglycidyl ether, 3,3-butylethyl-1,5-pentane diol diglycidyl ether, di-, tri- or tetra(ethylene glycol) diglycidyl ether, di-, tri- or tetra(1,2-propylene glycol) diglycidyl ether, di-, tri- or tetra(1,3-propylene glycol) diglycidyl ether, di-, tri- or tetra(1,4-butylene glycol) diglycidyl ether, a poly(ethylene glycol) diglycidyl ether, a poly(propylene glycol) diglycidyl ether, a poly(trimethylene glycol) diglycidyl ether, a poly(tetramethylene glycol) diglycidyl ether, a poly(ethylene glycol-co-propylene glycol) diglycidyl ether, glycerol triglycidyl ether, a polyglycerol polyglycidyl ether, trimethylolmethane triglycidyl ether, trimethylolethane triglycidyl ether, trimethylolpropane triglycidyl ether, di(trimethylolpropane) tetraglycidyl ether, pentaerythritol tetraglycidyl ether, diglycidyl cyclohexanedicarboxylate, cyclohexane diglycidyl ether, cyclohexane-1,4-dimethanol diglycidyl ether, tricyclodecane dimethanol diglycidyl ether, isosorbide diglycidyl ether, pyrocatechol diglycidyl ether, resorcinol diglycidyl ether, cardol diglycidyl ether, phloroglucinol triglycidyl ether, pyrogallol triglycidyl ether, tris(hydroxyphenyl)methane triglycidyl ether, tris(hydroxyphenyl)ethane triglycidyl ether, diglycidyl phthalate, diglycidyl terephthalate, diglycidyl isophthalate, polyglycidyl ethers of a polyether polyol obtained by the addition of one or more alkylene oxides to an aliphatic polyhydric alcohol such as ethylene glycol, propylene glycol, and glycerol, diglycidyl esters of aliphatic long-chain (C6-C22) dibasic acids, monoglycidyl ethers of aliphatic higher alcohols, monoglycidyl ethers of phenol, cresol, butyl phenol, or polyether alcohols obtained by the addition of alkylene oxide to these compounds, glycidyl esters of higher fatty acids, an epoxidized vegetable oil (such as epoxidized soybean oil and epoxidized linseed oil), epoxybutylstearic acid, epoxyoctylstearic acid, epoxidized polybutadiene, triglycidyl isocyanurate and the like.

Non-limiting examples of polyester (meth)acrylates are the reaction products of a hydroxyl group-terminated polyester polyol with a (meth)acrylating agent (such as (meth)acrylic acid, (meth)acrylic anhydride, (meth)acryloyl chloride or combinations thereof). The reaction process may be conducted such that a significant concentration of residual hydroxyl groups remain in the polyester (meth)acrylate or may be conducted such that all or essentially all of the hydroxyl groups of the polyester polyol have been (meth)acrylated. The polyester polyols can be made by polycondensation reactions of a polyhydroxyl functional component (in particular a diol) and a polycarboxylic acid functional compound (in particular, a dicarboxylic acid or anhydride). To prepare the polyester (meth)acrylates, the hydroxyl groups of the polyester polyol are then partially or fully esterified by reacting with the (meth)acrylating agent. Polyester (meth)acrylates may also be synthesized by reacting a hydroxyl-containing (meth)acrylate such as a hydroxyalkyl (meth)acrylate (e.g., hydroxyethyl acrylate) with a polycarboxylic acid. The polyhydroxyl functional and polycarboxylic acid functional components can each have linear, branched, cycloaliphatic or aromatic structures and can be used individually or as mixtures.

Non-limiting examples of polyether (meth)acrylates are the condensation reaction products of a polyetherol which is a polyether polyol with a (meth)acrylating agent (such as (meth)acrylic acid, (meth)acrylic anhydride, (meth)acryloyl chloride or combinations thereof). Suitable polyetherols can be linear or branched substances containing ether bonds and terminal hydroxyl groups. Polyetherols can be prepared by ring opening polymerization of epoxides and other oxygen-containing heterocyclic compounds (e.g., ethylene oxide, 1,2-propylene oxide, butene oxide, tetrahydrofuran and combinations thereof) with a starter molecule. Suitable starter molecules include water, hydroxyl functional materials, polyester polyols and amines. Polyetherols may also be obtained by the condensation of diols such as glycols.

Non-limiting examples of urethane (meth)acrylates are the condensation reaction products of at least one polyisocyanate (e.g., diisocyanate, triisocyanate), at least one polyol (such as a polyether polyol or a polyester polyol) and a hydroxyl-functionalized (meth)acrylate (such as 2-hydroxyethyl (meth)acrylate or 3-hydroxypropyl (meth)acrylate) to provide terminal (meth)acrylate groups. For example, the urethane (meth)acrylate may contain two, three, four or more (meth)acrylate groups per molecule. The order of addition of the components to prepare the urethane (meth)acrylate is well known in the art. For example, the hydroxyl-functionalized (meth)acrylate may be first reacted with the polyisocyanate to obtain an isocyanate-functionalized (meth)acrylate, which is then reacted with the polyol. In yet another embodiment, the polyisocyanate may be first reacted with the polyol to obtain an isocyanate-functionalized polyol, which is thereafter reacted with a hydroxyl-functionalized (meth)acrylate. Alternatively, all the components may be combined and reacted at the same time.

Non-limiting examples of (meth)acrylated poly(meth)acrylates are substances having an oligomeric (meth)acrylic backbone which is functionalized with one or (meth)acrylate groups (which may be at a terminus of the oligomer or pendant to the acrylic backbone). The (meth)acrylic backbone may be a homopolymer, random copolymer or block copolymer comprised of repeating units of (meth)acrylic monomers. The (meth)acrylic monomers may be any monomeric (meth)acrylate such as C₁-C₆ alkyl (meth)acrylates as well as functionalized (meth)acrylates such as (meth)acrylates bearing hydroxyl, carboxylic acid and/or epoxy groups. (Meth)acrylated poly(meth)acrylates may be prepared using any procedures known in the art, such as by oligomerizing (meth)acrylic monomers, at least a portion of which are functionalized with hydroxyl, carboxylic acid and/or epoxy groups (e.g., hydroxyalkyl(meth)acrylates, (meth)acrylic acid, glycidyl (meth)acrylate) to obtain a functionalized poly(meth)acrylate, which is then reacted with one or more (meth)acrylate-containing reactants to introduce the desired (meth)acrylate functional groups.

The curable composition may comprise from 0 to 80 wt. %, in particular from 5 to 75 wt. %, more particularly from 10 to 70 wt. %, even more particularly from 15 to 60 wt. %, more particularly still from 20 to 50 wt. % of (meth)acrylate-functionalized oligomer, based on the total weight of the curable composition. In particular, the curable composition may comprise from 0 to 50 wt. %, from 1 to 45 wt. %, from 5 to 40 wt. %, from 10 to 35 wt. % or 15 to 30 wt. % of (meth)acrylate-functionalized oligomer, based on the total weight of the polymerizable component.

In embodiments, the curable compositions may have a glass transition temperature T_{g} of about 20 °C or more when cured or about 30 °C or less when cured. In embodiments, the curable compositions may be liquid at a temperature of 25 °C+2 °C. In embodiments, the curable composition may have a viscosity, as measured by Brookfield DV-III viscometer using Spindle SC-27 at 60 °C, of equal to or less than 50,000 cP, such as equal to or less than 45,000 cP, equal to or less than 40,000 cP, equal to or equal than 35,000 cP, equal to or less than 30,000 cP, equal to or less than 25,000 cP, equal to or less than 20,000 cP, 15,000 cP or less, 12,500 cP or less, or even 10,000 cP or less. Such viscosity features facilitate spreading of the composition on a substrate for film formation.

In a preferred embodiment, the curable composition may have a viscosity, as measured by Brookfield DV-III viscometer using Spindle SC-27 at 25 °C, of equal to or less than 50,000 cP, such as equal to or less than 45,000 cP, equal to or less than 40,000 cP, equal to or equal than 35,000 cP, equal to or less than 30,000 cP, equal to or less than 25,000 cP, equal to or less than 20,000 cP, 15,000 cP or less, 12,500 cP or less, or even 10,000 cP or less.

In embodiments, the curable compositions may comprise less than 1 wt % of solvent and less than 1 wt % of water or are free of solvent and are free of water. In embodiments, a film or coating may be formed by curing the curable composition.

### Method of Preparing and Curing the Curable Composition

The invention also relates to a method of preparing the curable composition according to the invention. The method of preparing the curable composition comprises the following steps:
preparing an oligomer according to the invention dissolved in a non-reactive solvent;
adding the reactive diluent to obtain a diluted curable composition;
removing at least part of the non-reactive solvent from the diluted curable composition to obtain the curable composition according to the invention.

The oligomer dissolved in a non-reactive solvent may be prepared by solution polymerization as described above. The oligomer, the non-reactive solvent and the reactive diluent may be as defined above. The non-reactive solvent may be at least partly removed by heating the diluted curable composition, for example at a temperature of 40 °C or more, in particular 50 °C or more, more particularly 60 °C or more. The amount of non-reactive solvent after the removal step may be less than 1%, less than 0.5%, or even 0%, by weight of non-reactive solvent based on the weight of the curable composition.

The invention also relates to a method of curing the curable composition according to the invention. The method of curing the curable composition comprises curing the curable composition.

The curing step may be carried out at ambient temperature (i.e. 10-30 °C).

The curing step may be carried out by irradiating the composition with a light source having a wavelength and/or an intensity that is able to activate the polymerized chromophore monomer units of the oligomer of the invention and cause crosslinking of said oligomer and/or said reactive diluent. The curing step may be carried out in the absence of a photoinitiator other than the oligomer of the invention. In other words, the curable composition may comprise less than 0.1%, in particular less than 0.05%, more particularly less than 0.001%, even more particularly 0% by weight of photoinitiator other than the oligomer of the present invention, based on the weight of the curable composition.

The method of curing the curable composition of the invention may not involve a pre-curing step, in particular a step of curing at least part of the reactive diluent prior to crosslinking the oligomer of the invention, for example by irradiating the curable composition with a light source having a long wavelength and/or a low intensity in the presence of a photoinitiator other than the oligomer of the present invention. As used herein, a light source having a long wavelength and/or a low intensity is a light source that is not able to activate the polymerized chromophore monomer units of the oligomer of the invention and cause crosslinking of said oligomer and/or said reactive diluent. An example of a light source having a long wavelength and/or a low intensity is a blacklight (as opposed to a mercury vapor lamp which is able to activate chromophores comprising a benzophenone moiety or a LED-UV lamp which is able to activate chromophores comprising a thioxanthone moiety). Preferably, the method of curing the curable composition of the invention comprises a curing step in which at least part of the reactive diluent and at least part of the oligomer of the invention are simultaneously cured. Without being bound by theory, such a curing method is believed to enable the grafting of at least part of the reactive diluent on at least part of the oligomer of the invention.

### Coating

In embodiments, a coating can be formed by curing the curable composition. The process for the preparation of a cured coating according to embodiments comprises curing the curable composition. In particular, the curable composition may be cured by exposing the composition to radiation (such as visible radiation, UV radiation, LED radiation, laser radiation, electron-beam radiation, peroxide, accelerator and heat). More particularly, the curable composition may be fully cured by exposing the composition to ultraviolet (UV) radiation. The ultraviolet curable composition may advantageously be cured by exposing the composition to a LED light source.

Prior to curing, the ultraviolet curable composition may be applied to a substrate surface in any known conventional manner, for example, by spraying, jetting, knife coating, roller coating, casting, drum coating, dipping, and the like and combinations thereof. Indirect application using a transfer process may also be used.

The substrate on which the ultraviolet curable composition is applied and cured may be any kind of substrate. When used as an adhesive, the polymerizable composition may be placed between two substrates and then cured, the cured composition thereby bonding the substrates together to provide an adhered article. Ultraviolet curable compositions in accordance with the present disclosure may also be formed or cured in a bulk manner (e.g., the ultraviolet curable composition may be cast into a suitable mold and then cured).

A plurality of layers of the ultraviolet curable composition in accordance with the present disclosure may be applied to a substrate surface; the plurality of layers may be simultaneously cured (by exposure to a single dose of radiation, for example) or each layer may be successively cured before application of an additional layer of the ultraviolet curable composition.

In embodiments, the coating can have a gel content of from 30% to 99%, as measured by the method, “Method A—Gel Content”, disclosed herein. For instance, the coating can have a gel content of from 30% to 95%, from 40% to 80%, from 50% to 70%, or any and all subranges formed from any of these endpoints.

Without intending to be bound by any particular theory, it is believed that the oligomer comprising the polymerized high-T_{g} monomer units, the polymerized low-T_{g} monomer units, the polymerized chromophore monomer units, and optionally, the at least one polymerized additional monomer unit can be cured to form a coating with a high gel content, and thus a high degree of crosslinking. Further, it is believed that the oligomer having a T_{g} of equal to or greater than 0 °C, can be cured to form a coating with a higher gel content than conventional oligomers that also have a T_{g} of equal to or greater than 0 °C. It is believed that the oligomers comprising the polymerized high-T_{g} monomers, as disclosed herein, may undergo a greater degree of hydrogen abstraction and crosslinking during curing, which may improve the strength of coatings formed from oligomers described herein.

### Examples

The various embodiments disclosed herein will be further clarified by the following examples. The examples are illustrative in nature, and should not be understood to limit the embodiments disclosed herein.

### Material

The following materials were used in the examples:

TABLE 1

| Abbreviation | Chemical name | Supplier |
|---|---|---|
| BENZO | 4-acryloyloxy | Sigma Aldrich Chemical |
| | benzophenone | Company |
| MEK | methyl ethyl ketone | Sigma Aldrich Chemical |
| | | Company |
| BA | butyl acrylate | Sigma Aldrich Chemical |
| | | Company |
| TBA | tert-butyl acrylate | Sigma Aldrich Chemical |
| | | Company |
| TBMA | tert-butyl methacrylate | Sigma Aldrich Chemical |
| | | Company |
| MMA | methyl methacrylate | Sigma Aldrich Chemical |
| | | Company |
| IBOMA | isobornyl methacrylate | Sartomer |
| (SR423) | | |
| SR506A | isobornyl acrylate | Sartomer |
| SR420 | 3,3,5-trimethylcyclohexyl | Sartomer |
| | acrylate | |
| SR421A | 3,3,5-trimethylcyclohexyl | Sartomer |
| | methacrylate | |
| SR217 | 4-tertbutyl cyclohexyl | Sartomer |
| | acrylate | |
| SR218 | 4-tertbutyl cyclohexyl | Sartomer |
| | methacrylate | |
| SR355 | Di(trimethylolpropane) | Sartomer |
| | tetraacrylate | |

### Formulation

Tables 2 shows the components (in weight percent) used to form the oligomer and certain properties of Comparative Examples C1 to C26 and Examples E1 to E21

The oligomers were obtained by solution polymerization of the monomers indicated in Table 2 using an amount of MEK as solvent as indicated in Table 2. The solvent and monomers were added to a 60 mL vial. A Vazo 52 initiator solution in the solvent was prepared in a separate vial, then added to the monomer solution (total monomer:initiator weight ratio of 400:1). The vial was then put into a water bath at 65 °C and lightly shaken for 11 hours. The type of solvent, solids content, reaction temperature, reaction time and initiator:monomer ratio can be adjusted to produce oligomers of various molecular weights using experimental conditions well known by those skilled in the art. Monomer:Vazo 52 ratios between 100:1 and 1000:1 were typically used to produce oligomers of relatively low molecular weights as described and used in the following examples.

Formulations for evaluating the cure speed according to Method B below were made by adding the components listed in Tables 2 to SR355 in a Flacktek® polypropylene cup and mixed until homogenous at 1500 rpm for two minutes using a Flacktek® DAC 400.2 VAC high-speed mixer.

TABLE 2

| | | | | | Weight |
|---|---|---|---|---|---|
| | | | | | average |
| | | | | | molecular |
| | | | Final MEK | Predicted | weight |
| Example | Backbone (wt %) | | (wt %) | Tg (°C) | (M_{w}) |
| C1 | BA | 95 | 37.9 | −48 | 32522 |
| | MMA | 4 | | | |
| | BENZO | 1 | | | |
| C2 | BA | 80 | 42.5 | −26 | 23856 |
| | MMA | 15 | | | |
| | BENZO | 5 | | | |
| C3 | MMA | 99 | 32.8 | 109 | 14181 |
| | BENZO | 1 | | | |
| C4 | BA | 80 | 40.7 | −31 | 25162 |
| | TBA | 15 | | | |
| | BENZO | 5 | | | |
| C5 | BA | 95 | 53.4 | −49 | 21960 |
| | TBA | 4 | | | |
| | BENZO | 1 | | | |
| C6 | BA | 91.16 | 44.0 | −38 | 24958 |
| | MMA | 3.84 | | | |
| | BENZO | 5 | | | |
| E1 | BA | 54.5 | 50.0 | 0 | 19636 |
| | MMA | 44.5 | | | |
| | BENZO | 1 | | | |
| E2 | BA | 38.5 | 49.4 | 25 | 19092 |
| | MMA | 60.5 | | | |
| | BENZO | 1 | | | |
| E3 | BA | 25 | 50.1 | 50 | 16620 |
| | MMA | 74 | | | |
| | BENZO | 1 | | | |
| C7 | BA | 69.5 | 32.5 | −20 | 26563 |
| | MMA | 26.5 | | | |
| | BENZO | 1 | | | |
| C8 | BA | 62.5 | 50.0 | −13 | 33063 |
| | MMA | 36.5 | | | |
| | BENZO | 1 | | | |
| C9 | BA | 95 | 50.0 | −32.0 | 43460 |
| | IBOMA | 4 | | | |
| | BENZO | 1 | | | |
| C10 | IBOMA | 99 | 50.0 | 66.8 | 26683 |
| | BENZO | 1 | | | |
| C11 | BA | 69.5 | 50.0 | −8.0 | 38680 |
| | IBOMA | 29.5 | | | |
| | BENZO | 1 | | | |
| C12 | BA | 91.2 | 50.0 | −28.3 | 48047 |
| | IBOMA | 3.8 | | | |
| | BENZO | 5 | | | |
| C13 | BA | 54.5 | 50.0 | −1.0 | 38596 |
| | IBOMA | 44.5 | | | |
| | BENZO | 1 | | | |
| E4 | BA | 38.5 | 50.0 | 24.0 | 34904 |
| | IBOMA | 60.5 | | | |
| | BENZO | 1 | | | |
| E5 | BA | 25 | 50.0 | 50.0 | 31343 |
| | IBOMA | 74 | | | |
| | BENZO | 1 | | | |
| C14 | BA | 62.5 | 50.0 | −20.0 | 38855 |
| | IBOMA | 36.5 | | | |
| | BENZO | 1 | | | |
| C15 | MMA | 19.2 | 50 | −10 | 31321 |
| | IBOMA | 19.2 | | | |
| | BA | 60.6 | | | |
| | BENZO | 1 | | | |
| E6 | MMA | 22.8 | 50 | 0 | 29925 |
| | IBOMA | 22.8 | | | |
| | BA | 53.4 | | | |
| | BENZO | 1 | | | |
| E7 | MMA | 30.7 | 50 | 25 | 26814 |
| | IBOMA | 30.7 | | | |
| | BA | 37.5 | | | |
| | BENZO | 1 | | | |
| E8 | MMA | 37.4 | 50 | 50 | 24125 |
| | IBOMA | 37.4 | | | |
| | BA | 24.1 | | | |
| | BENZO | 1 | | | |
| C16 | SR217 | 54.3 | 50 | −10 | 64232 |
| | BA | 44.7 | | | |
| | BENZO | 1 | | | |
| E9 | SR217 | 74.4 | 50 | 0 | 60937 |
| | BA | 24.6 | | | |
| | BENZO | 1 | | | |
| E10 | SR217 | 86.9 | 50 | 25 | 66424 |
| | BA | 12.2 | | | |
| | BENZO | 1 | | | |
| E11 | SR217 | 99 | 50 | 40.6 | 69056 |
| | BENZO | 1 | | | |
| C17 | SR218 | 35.7 | 50 | −10 | 42744 |
| | BA | 63.3 | | | |
| | BENZO | 1 | | | |
| E12 | SR218 | 42.4 | 50 | 0 | 41389 |
| | BA | 56.6 | | | |
| | BENZO | 1 | | | |
| E13 | SR218 | 57.2 | 50 | 25 | 40587 |
| | BA | 41.8 | | | |
| | BENZO | 1 | | | |
| E14 | SR218 | 69.6 | 50 | 50 | 39028 |
| | BA | 29.4 | | | |
| | BENZO | 1 | | | |
| C18 | IBOA | 41.5 | 50 | −10 | 40802 |
| | BA | 57.5 | | | |
| | BENZO | 1 | | | |
| E15 | IBOA | 49.2 | 50 | 0 | 40126 |
| | BA | 49.8 | | | |
| | BENZO | 1 | | | |
| E16 | IBOA | 66.3 | 50 | 25 | 36987 |
| | BA | 32.7 | | | |
| | BENZO | 1 | | | |
| E17 | IBOA | 80.8 | 50 | 50 | 34034 |
| | BA | 18.2 | | | |
| | BENZO | 1 | | | |
| C19 | TBMA | 37.1 | 50 | −10 | 32286 |
| | BA | 61.9 | | | |
| | BENZO | 1 | | | |
| E18 | TBMA | 44 | 50 | 0 | 33111 |
| | BA | 55 | | | |
| | BENZO | 1 | | | |
| E19 | TBMA | 59.3 | 50 | 25 | 27634 |
| | BA | 39.7 | | | |
| | BENZO | 1 | | | |
| E20 | TBMA | 72.3 | 50 | 50 | 26580 |
| | BA | 26.7 | | | |
| | BENZO | 1 | | | |
| C20 | SR420 | 59.3 | 50 | −10 | 108348 |
| | BA | 39.1 | | | |
| | BENZO | 1 | | | |
| E21 | SR420 | 70.4 | 50 | 0 | 81585 |
| | BA | 28.6 | | | |
| | BENZO | 1 | | | |
| E22 | SR420 | 94.9 | 50 | 25 | 65590 |
| | BA | 4.1 | | | |
| | BENZO | 1 | | | |
| E23 | SR420 | 99 | 50 | 30 | 92069 |
| | BA | 0 | | | |
| | BENZO | 1 | | | |
| C21 | SR421A | 34.3 | 50 | −10 | 59746 |
| | BA | 64.7 | | | |
| | BENZO | 1 | | | |
| E24 | SR421A | 40.7 | 50 | 0 | 56574 |
| | BA | 58.3 | | | |
| | BENZO | 1 | | | |
| E25 | SR421A | 54.8 | 50 | 25 | 51756 |
| | BA | 44.2 | | | |
| | BENZO | 1 | | | |
| E26 | SR421A | 66.8 | 50 | 50 | 48413 |
| | BA | 32.2 | | | |
| | BENZO | 1 | | | |

### Methods

The following methods were used in the application:

### Molecular Weight

The number average molecular weight (Mn) and weight average molecular weight (Mw) of the oligomers were determined using a size exclusion chromatography (SEC) using poly(methyl methacrylate) reference standards and tetrahydrofuran as the solvent with the following conditions:
Columns: Agilent PLgel 5 micron 100 A, 250×4.6 mm; Agilent PLgel 3 micron MiniMix E, 250×4.6 mm; Agilent PLgel 5 micron MiniMix D, 250×4.6 mm,
Detector: refractive index detector.
Flow rate of solvent: 0.45 μL/min
Temperature: 40 °C
Volume of sample injection: 25 μL.

### Method A—Gel Content

The gel content of the neat oligomers were measured by curing a 3 MIL wet coating using an H bulb (small Fusion LC6, 15 fpm, three passes). The draw-down thickness depended on the final MEK percentage in the oligomer. For instance, if the examples were provided as either 60% monomers and 40% MEK, or 50% monomers and 50% MEK, then the examples having 40% MEK were drawn down from 5 MIL thick and the examples having 50% MEK were drawn down from 6 MIL thick such that after evaporation of MEK, the film thickness is 3 MIL. After the draw-down, the glass slides were placed in a 60 °C oven for 1 hour to remove the solvent. The samples were cured in air or nitrogen. The samples were removed from the glass slides after curing and placed in a solution of MEK for 24 hours. Gel content was given as a percentage of the remaining weight of the sample after 24 hours of soaking in MEK as compared to the initial weight of the sample as given by the equation below.

$$Gel content ( \% ) = \frac{final weight}{i n itial weight} * 100$$

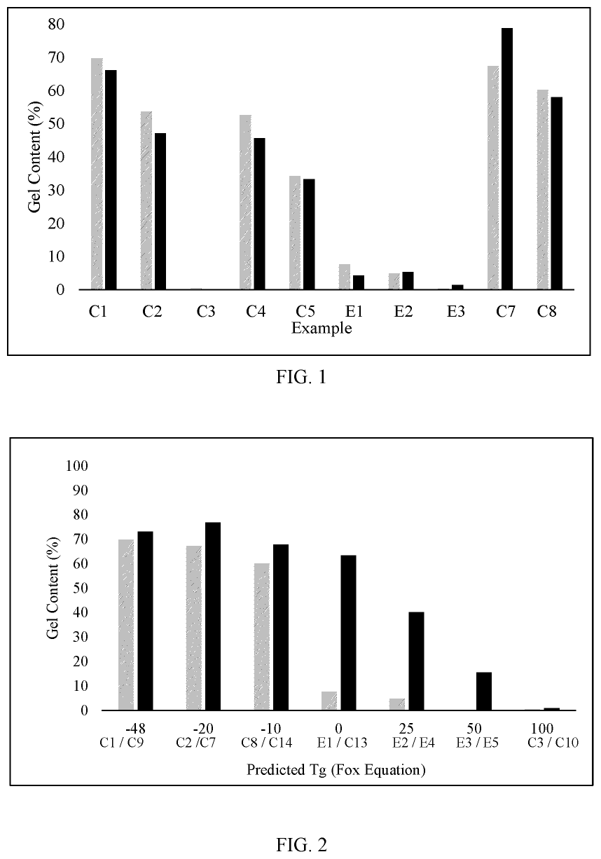

Referring now to FIG. 1, environment (i.e., air (shown in gray bars) or nitrogen (shown in black bars) had minimal effect on gel content. Example E1, an oligomer including 54.5 wt % BA, 44.5 wt % MMA, and 1 wt % BENZO, had a gel content of less than 5 wt % when cured in air and nitrogen. On the other hand, Comparative Example C7, an oligomer including 69.5 wt % BA, 26.5 wt % MMA, and 1 wt % BENZO, had a gel content of 67 wt % (air) and 79% (nitrogen). As exemplified by FIG. 1 and table 1, gel content decreases and T_{g} increases as MMA, a high T_{g} monomer unit, increases. Accordingly, the amount of polymerized high T_{g} monomer units and polymerized low T_{g} monomer units in the oligomer may be tailored to achieve both a desired crosslinking amount, as indicated gel content and T_{g}.

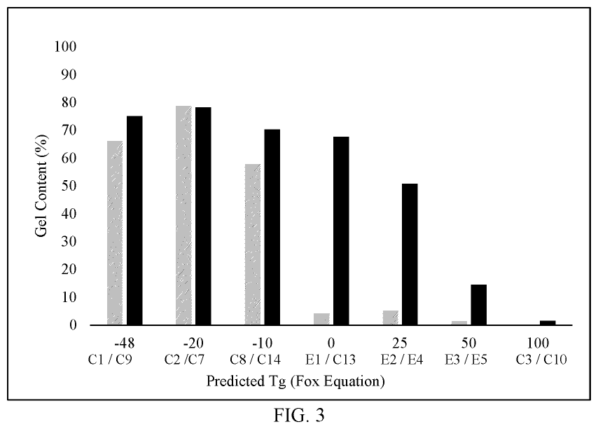

Referring now to FIGS. 2 and 3, replacement of MMA with an alternate high T_{g} monomer unit, IBOMA, showed improvement in gel content whether cured in air (FIG. 2) or nitrogen (FIG. 3) when normalized by the predicted T_{g} of the examples. For instance, Example E2, an oligomer including 38.5 wt % BA, 60.4 wt % MMA, and 1 wt % BENZO, had a predicted T_{g} of 25 °C, and a gel content of 5 wt % (air and nitrogen). Example E4, an oligomer including 38.5 wt % BA, 50.4 wt % IBOMA, and 1 wt % BENZO, had a predicted T_{g} of 24 °C, and a gel content of 40 wt % (air) and 51 wt % (nitrogen). As exemplified by FIG. 2, FIG. 3, and table 1, the selection of certain polymerized high T_{g} monomer units and the amount of polymerized high T_{g} monomer units and polymerized low T_{g} monomer units in the oligomer may be tailored to achieve both a desired crosslinking amount, as indicated gel content and higher T_{g}.

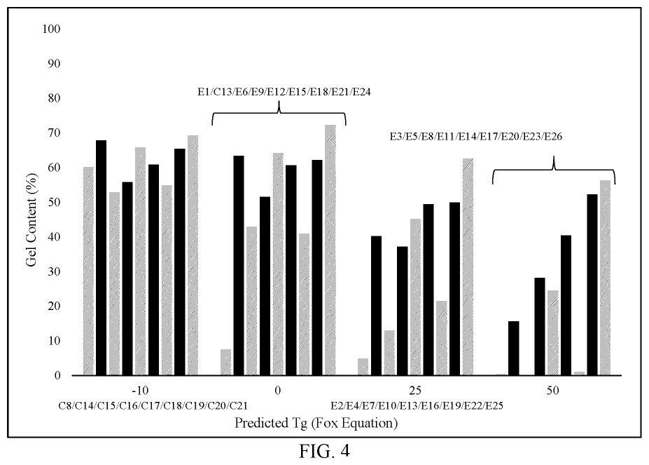

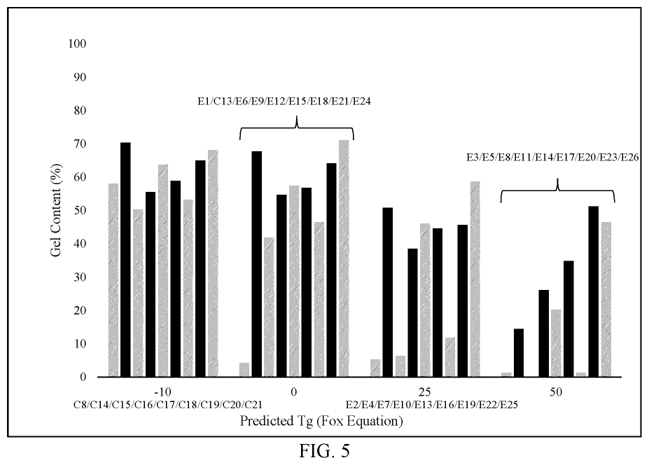

Referring now to FIGS. 4 and 5, replacement of MMA with alternative high-T_{g} monomer units such as SR506 A and tBMA, showed improvement in gel content whether cured in air (FIG. 4) or nitrogen (FIG. 5) when normalized by the predicted T_{g} of the examples. Further, replacing IBOMA with other cycloaliphatic moieties, such as SR421 A, and SR218, resulted in a higher gel content at copolymer ratio that result in a T_{g} of 25 °C and 50 °C, respectively. While not wishing to be bound by theory, the incorporation of a cycloaliphatic moiety may allow for neighboring acrylic copolymer chains to initiate hydrogen abstraction faster and more efficiently, due to availability of tertiary protons on the cycloaliphatic ring, unlike a copolymer containing MMA. Furthermore, the size of the cycloaliphatic comonomer and availability of numerous sites for hydrogen abstraction may give neighboring chains more available protons with less steric hindrance compared to a small aliphatic comonomer, such as MMA.

As exemplified by FIGS. 2-5 and table 1, the high-T_{g} monomer unit used may be tailored to achieve a desired crosslinking amount at given copolymer ratios, as indicated by gel content.

### Method B—Photo Differential Scanning Calorimetry (PhotoDSC)

Examples were combined with SR355 in an initial weight ratio of oligomer:SR355 and were placed in a Tzero pan and residual solvent was flashed off in the oven. The initial weight ratio of the oligomer:SR355 was selected to achieve a 1:1 weight ratio of oligomer:SR355 after the solvent was flashed off. The samples were exposed to a broad spectrum UV light (100 mW/cm²) for two minutes.

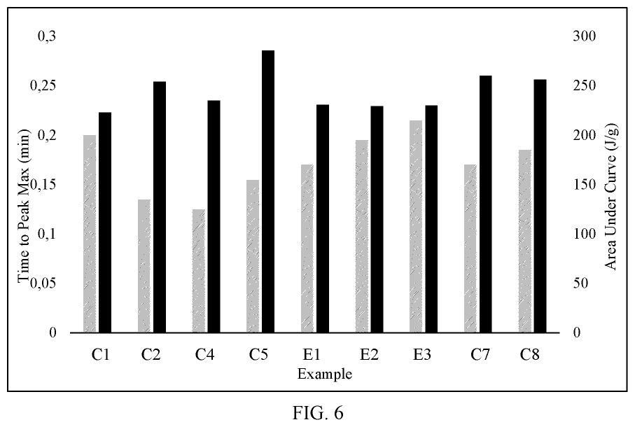

Referring now to FIG. 6, the time it took to reach peak maximum was recorded (shown by gray bars in FIG. 6) to determine cure speeds of each oligomer. The heat flow under each curve was measured during cure (shown in black bars in FIG. 6). As exemplified by FIG. 6, the cure speed increased as the amount of MMA increased. Accordingly, the amount of polymerized high T_{g} monomer units and polymerized low T_{g} monomer units in the oligomer may be tailored to achieve a desired cure speed. Moreover, all examples in FIG. 6 induced crosslinking with SR355.

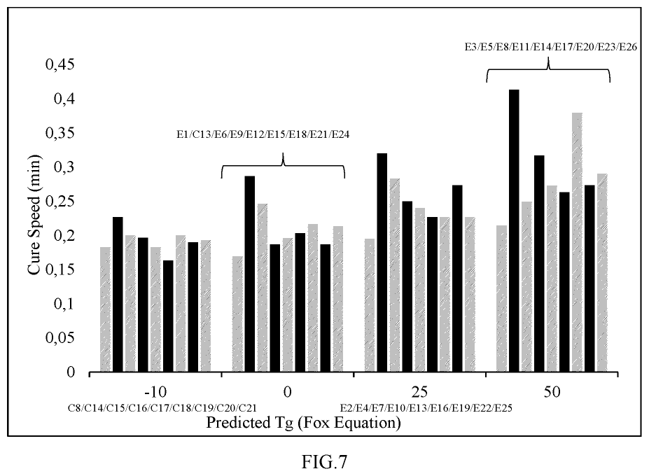

Referring now to FIG. 7, the time it took to reach peak maximum was recorded to determine cure speeds of each oligomer. As exemplified by FIG. 7, all examples had similar cure speeds. Cure speeds tended to slow down as the T_{g} of the oligomer increased. Accordingly, the amount of polymerized high T_{g} monomer units and polymerized low T_{g} monomer units in the oligomer may be tailored to adjust the oligomer T_{g} and achieve a desired cure speed.

UV curable coatings compositions were made by adding enough oligomer to ditrimethylolpropane tetraacrylate (SR355) so that the resulting composition had a 1:1 weight ratio of oligomer to SR355 after MEK evaporation. The UV curable coatings compositions were mixed until homogenous at 1500 rpm for 2 minutes using a Flacktek® DAC 400.2 VAC high speed mixer.

The gel content was measured by curing a 4 MIL wet coating of the UV curable coatings compositions on glass slides. After the draw-down, the glass slides were placed in a 60 °C oven for 1 hour to remove the solvent. The samples were cured in air or nitrogen. For air: After drying in the oven, samples were cured using a small Fusion LC6 microwave bulb, 15 feet per minute, three passes. For nitrogen: After drying in the oven, samples were placed in a nitrogen chamber and nitrogen flow was applied for five minutes. The nitrogen chamber with quartz window was passed under the Fusion LC6 microwave bulb, 15 feet per minute, three passes. The samples were removed from the glass slides after curing and placed in a solution of MEK for 24 hours. Gel content was given as a percentage of the remaining weight of the sample after 24 hours of soaking in MEK compared to the initial weight of the sample as given by the equation below.

$$Gel content ( \% ) = \frac{final weight}{i n itial weight} * 100$$

The gel content of a UV curable coatings composition containing Oligomer E5 with SR355 was 59.1%±1.4% in air and 57.7%±0.6% in nitrogen. The gel content of a UV curable coatings composition containing Oligomer E12 with SR355 was 64.1%±1.2% in air and 60.9%±5.4% in nitrogen.

### Aspects

Further aspects of the invention are provided by the subject matter of the following clauses:

Clause 1. An oligomer comprising: comprising, based on the total weight of the oligomer: from 1% to 95% by weight polymerized high-T_{g} monomer units, from 0.1% to 98.9% by weight polymerized low-T_{g} monomer units, from 0.1% to 40% by weight polymerized chromophore monomer units, and from 0 to 20% by weight at least one polymerized additional monomer unit; wherein: the high-T_{g} monomer units are (meth)acrylate monomers having a Fox Equation average glass transition temperature (T_{g}) equal to or greater than 25 °C, the low-T_{g} monomer units are monovalent (meth)acrylate monomers having a Fox Equation average T_{g} less than 25 °C, the Fox Equation average T_{g} of the high-T_{g} monomer units is at least 20 °C greater than the Fox Equation average T_{g} of the low-T_{g} monomer units, the chromophore monomer units are (meth)acrylate monomers having a pendent Norrish Type II chromophore, the oligomer has a weight average molecular weight of at least 10,000 grams per mole (g/mol), and the oligomer has a T_{g} equal to or greater than 0 °C.

Clause 2. The oligomer of any preceding clause, wherein the oligomer is according to formula (I) below:

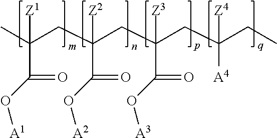

each A¹ is independently (C₁-C₃₀)hydrocarbyl or (C₁-C₃₀)heterohydrocarbyl, preferably (C₁-C₃₀)hydrocarbyl, more preferably at least part of the A¹ moieties are chosen from isobutyl, tert-butyl or a cyclic (C₁-C₃₀)hydrocarbyl;
each A² is independently (C₂-C₃₀)hydrocarbyl or (C₂-C₃₀)heterohydrocarbyl, preferably a (C₄-C₃₀)hydrocarbyl;
each A³ is independently a monovalent residue comprising the Norrish Type II chromophore, preferably a monovalent residue comprising a benzophenone;
each A⁴ is independently a (C₁-C₃₀)hydrocarbyl or (C₁-C₃₀)heterohydrocarbyl, preferably a —(C₁-C₃₀)heterohydrocarbyl bearing a functional group selected from an acidic group, a nitrogen-containing group, a hydroxyl group, an epoxy group, a carbonyl group, an acetoacetoxy group, an acetoacetamide group, a 1,1-dimethyl-3-oxobuyl (diacetone) group, a thiol group, a silane group, an ether bond, an ester bond, and combinations thereof,
Z¹, Z², Z³, and Z⁴ are independently —H or —CH₃;
m is a weight fraction of the polymerized high-T_{g} monomer units, in particular m is from 0.01 to 0.95;
n is a weight fraction of the polymerized low-T_{g} monomer units, in particular n is 0.001 to 0.989;
p is a weight fraction of the polymerized chromophore monomer units, in particular p is 0.001 to 0.4;
q is a weight fraction of the at least one polymerized additional monomer units and optionally is zero, in particular q is 0 to 0.20; and
m+n+p+q is equal to 1.

Clause 3. The oligomer of any preceding clause, wherein at least part of the A¹ moieties is chosen from isobutyl, tert-butyl, a substituted or unsubstituted (C₆-C₁₂)cycloalkyl optionally combined with an alkylene moiety, a substituted or unsubstituted (C₆-C₁₂)aryl optionally combined with an alkylene or oxyalkylene moiety, or combinations thereof, A² is a linear or branched (C₄-C₃₀)alkyl or combinations thereof, and A³ is X or -L-X, where L is a (C₁-C₁₀)heterohydrocarbylene linker and X is a monovalent residue of the Norrish Type II chromophore.

Clause 4. The oligomer of any preceding clause, wherein at least part of the A¹ moieties is chosen from isobutyl, tert-butyl, isobornyl, cyclohexyl, 3,3,5-trimethylcyclohexyl, tert-butylcyclohexyl, benzyl, adamantyl, dicyclopentanyl, tricyclodecyl, —CH₂-tricyclodecyl, phenyl, —CH₂—CH₂-phenyl, or —CH₂—CH₂—O-phenyl, or combinations thereof, A² is chosen from n-butyl, isobutyl, hexyl, 2-ethylhexyl, isooctyl, isodecyl, tridecyl, lauryl, or combinations thereof, and A³ is a monovalent residue of the Norrish Type II chromophore.

Clause 5. The oligomer of any preceding clause, wherein the Norrish Type II chromophore is chosen from benzophenones, thioxanthones, or titanocenes.

Clause 6. The oligomer of any preceding clause, wherein A³ is -L-X, where L is a (C₁-C₁₀)heterohydrocarbylene linker and X is a monovalent radical of benzophenone.

Clause 7. The oligomer of any preceding clause, wherein at least part of the A¹ moieties is chosen from isobutyl, tert-butyl, isobornyl, cyclohexyl, 3,3,5-trimethylcyclohexyl, tert-butylcyclohexyl, benzyl, adamantyl, dicyclopentanyl, tricyclodecyl, —CH₂-tricyclodecyl, phenyl, —CH₂—CH₂-phenyl, or —CH₂—CH₂—O-phenyl, A² is n-butyl, and A³ is a monovalent residue of benzophenone.

Clause 8. The oligomer of any preceding clause, wherein A³ has formula (IVa) as disclosed below:

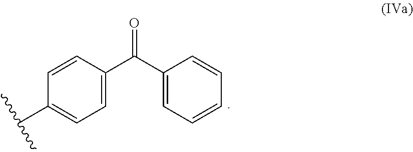 [SMILES: *c1ccc(C(=O)c2ccccc2)cc1]

Clause 9. The oligomer of any preceding clause, wherein q is from 0.001 to 0.20, preferably 0.001 to 0.10, and the additional monomer units comprise a functional group selected from an acidic group, a heterocycle with one or more nitrogen ring atoms, tertiary amine functionality, alkylenoxy functionality or a mercaptan group, preferably the additional monomer units are chosen from (meth)acrylic acid, dimethylaminoethylacrylate, dimethylaminoethylmethacrylate, diethylaminoethyl acrylate, diethylaminoethyl methacrylate, N-vinylpyrrolidone, N-vinylcaprolactam, acryloxymorpholine, dimethyl acrylamide, a poly(ethylenoxide) mono(meth)acrylate, hydroxyethyl ethylene urea (meth)acrylate, the reaction product of a cyclic anhydride with a hydroxy-functional (meth)acrylate, and combinations thereof.

Clause 10. The oligomer of any preceding clause, wherein the oligomer has formula (V):

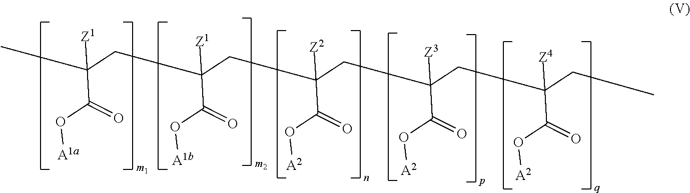

wherein:
   each A¹a is independently chosen from isobutyl, tert-butyl or a cyclic (C₁-C₃₀)hydrocarbyl;
   each A^{1b} is independently chosen from a (C₁-C₃₀)hydrocarbyl other than isobutyl, tert-butyl or a cyclic (C₁-C₃₀)hydrocarbyl;
   each A² is independently (C₂-C₃₀)hydrocarbyl or (C₂-C₃₀)heterohydrocarbyl;
   each A³ is independently a monovalent residue comprising the Norrish Type II chromophore, preferably a monovalent residue comprising a benzophenone;
   each A⁴ is independently a (C₁-C₃₀)hydrocarbyl or (C₁-C₃₀)heterohydrocarbyl, preferably a —(C₁-C₃₀)heterohydrocarbyl bearing a functional group selected from an acidic group, a nitrogen-containing group, a hydroxyl group, an epoxy group, a carbonyl group, an acetoacetoxy group, an acetoacetamide group, a 1,1-dimethyl-3-oxobuyl (diacetone) group, a thiol group, a silane group, an ether bond, an ester bond, and combinations thereof,
   Z¹, Z², Z³, and Z⁴ are independently —H or —CH₃;
   m₁ is 0.01 to 0.95, in particular from 0.20 to 0.90, more particularly from 0.25 to 0.85, even more particularly from 0.30 to 0.80, more particularly yet from 0.35 to 0.75, more particularly still from 0.40 to 0.75;
   m₂ is 0 to 0.94, in particular from 0 to 0.90, more particularly from 0 to 0.80, even more particularly from 0 to 0.70, more particularly yet from 0 to 0.60, more particularly still from 0 to 0.50;
   n is 0.001 to 0.989, in particular from 0.10 to 0.80, more particularly from 0.15 to 0.75, even more particularly from 0.20 to 0.70, more particularly yet from 0.25 to 0.65, more particularly still from 0.25 to 0.60;
   p is 0.001 to 0.40, in particular from 0.005 to 0.30, more particularly from 0.005 to 0.20, even more particularly from 0.005 to 0.15; more particularly yet from 0.005 to 0.10, more particularly still from 0.01 to 0.10;
   q is 0 to 0.20, in particular from 0 to 0.10; and
   m₁+m₂+n+p+q is equal to 1;
   m₁+m₂ is from 0.01 to 0.95, in particular 0.20 to 0.90, more particularly from 0.25 to 0.85, even more particularly from 0.30 to 0.80, more particularly yet from 0.35 to 0.75, more particularly still from 0.40 to 0.75.

Clause 11. The oligomer of any preceding clause, according to formula (V) as described below:

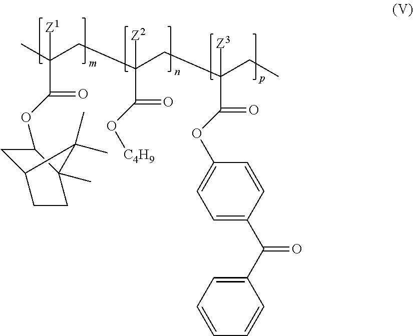

where: m is from 0.2 to 0.8, n is from 0.1 to 0.8, and p is from 0.001 to 0.2; Z¹, Z², and Z³ of formula (V) are independently —H or —CH₃; and wherein the oligomer has a weight average molecular weight of at least 20,000 g/mol.

Clause 12. The oligomer of any preceding clause, wherein Z¹ is H or —CH₃, Z², and Z³ are —H, and Z⁴ is —H, if q is greater than 0.

Clause 13. The oligomer of any preceding clause, wherein the T_{g} of the oligomer is from 0 °C to 100 °C, in particular from 20 °C to 100 °C, more particularly from 30 to 100 °C.

Clause 14. The oligomer of any preceding clause, wherein the additional monomer units are (meth)acrylate monomers.

Clause 15. The oligomer of any preceding clause, wherein the additional monomer units are (meth)acrylate monomers having a pendent amine functionality.

Clause 16. The oligomer of any preceding clause, wherein q is from 0.001 to 0.20, preferably from 0.001 to 0.10, and the additional monomer units are chosen from dimethylaminomethyl (meth)acrylate, dimethylaminoethyl (meth)acrylate, morpholino (meth)acrylate), dimethylamino (methacrylate), or combinations thereof.

Clause 17. The oligomer of any preceding clause, wherein: m is from 0.40 to 0.90, n is from 0.10 to 0.60, and p is from 0.005 to 0.03.

Clause 18. The oligomer of any preceding clause, wherein: m is from 0.70 to 0.90, n is from 0.10 to 0.30, and p is from 0.005 to 0.03.

Clause 19. The oligomer of any preceding clause, wherein: m is from 0.40 to 0.60, n is from 0.40 to 0.60, and p is from 0.005 to 0.03.

Clause 20. The oligomer of any preceding clause, wherein the oligomer, upon curing, has a gel content of at least 10%.

Clause 21. The oligomer of any preceding clause, wherein the oligomer, upon curing, has a gel content of at least 20%.

Clause 22. A curable composition comprising the oligomer according to any preceding clause and one or more of the following compounds: (meth)acrylate monomers, diluents, (meth)acrylate oligomers, fillers, photoinitiators, slip agents, thickeners, slip agents, hindered amine light stabilizers, ultraviolet absorbing monomers, or other auxiliary additives.

Clause 23. The curable composition of clause 22, wherein the curable composition comprises a reactive diluent.

Clause 24. The curable composition of clause 23, wherein the reactive diluent comprises a monofunctional (meth)acrylate monomer having a T_{g} that is higher than 25 °C, in particular a monofunctional (meth)acrylate monomer selected from 2-phenylethyl methacrylate, neopentyl methacrylate, 3,3,5-trimethylcyclohexyl acrylate, tert-butyl acrylate, octadecyl methacrylate, octadecyl acrylate, glycidyl methacrylate, propyl methacrylate, tetrahydrofurfuryl methacrylate, benzyl methacrylate, isobutyl methacrylate, glycidyl methacrylate, ethyl methacrylate, 2,2,3,3-tetrafluoropropyl methacrylate, 2-hydroxypropyl methacrylate, 2,2,2-trifluoroethyl methacrylate, 2-hydroxyethyl methacrylate, isopropyl methacrylate, isobornyl acrylate, methyl methacrylate, butyl cyanoacrylate, isobornyl methacrylate, phenyl methacrylate, 2-cyanobutyl acrylate, tert-butyl methacrylate, cyclohexyl acrylate, cyclohexyl methacrylate, 4-tert-butylcyclohexyl acrylate, 4-tert-butylcyclohexyl methacrylate, ethyl cyanoacrylate, methyl cyanoacrylate, 3,3,5-trimethylcyclohexyl acrylate, 3,3,5-trimethylcyclohexyl methacrylate, a substituted or unsubstituted (C₆-C₁₂)cycloalkyl (meth)acrylate, adamantyl (meth)acrylate, dicyclopentanyl (meth)acrylate, tricyclodecane methanol mono(meth)acrylate, 2-phenoxyethyl methacrylate, or combinations thereof.

Clause 25. The curable composition of clause 23 or 24, wherein the reactive diluent comprises a polyfunctional (meth)acrylate, in particular a polyfunctional (meth)acrylate selected from bisphenol A di(meth)acrylate; hydrogenated bisphenol A di(meth)acrylate; ethylene glycol di(meth)acrylate; diethylene glycol di(meth)acrylate; triethylene glycol di(meth)acrylate; tetraethylene glycol di(meth)acrylate; polyethylene glycol di(meth)acrylate; propylene glycol di(meth)acrylate; dipropylene glycol di(meth)acrylate; tripropylene glycol di(meth)acrylate; tetrapropylene glycol di(meth)acrylate; polypropylene glycol di(meth)acrylate; polytetramethylene glycol di(meth)acrylate; 1,2-butanediol di(meth)acrylate; 2,3-butanediol di(meth)acrylate; 1,3-butanediol di(meth)acrylate; 1,4-butanediol di(meth)acrylate; 1,5-pentanediol di(meth)acrylate; 1,6-hexanediol di(meth)acrylate; 1,8-octanediol di(meth)acrylate; 1,9-nonanediol di(meth)acrylate; 1,10-nonanediol di(meth)acrylate; 1,12-dodecanediol di(meth)acrylate; neopentyl glycol di(meth)acrylate; 2-methyl-2,4-pentanediol di(meth)acrylate; polybutadiene di(meth)acrylate; cyclohexane-1,4-dimethanol di(meth)acrylate; tricyclodecane dimethanol di(meth)acrylate; metallic di(meth)acrylates; modified metallic di(meth)acrylates; glyceryl di(meth)acrylate; glyceryl tri(meth)acrylate; trimethylolethane tri(meth)acrylate; trimethylolethane di(meth)acrylate; trimethylolpropane tri(meth)acrylate; trimethylolpropane di(meth)acrylate; pentaerythritol di(meth)acrylate; pentaerythritol tri(meth)acrylate; pentaerythritol tetra(meth)acrylate, di(trimethylolpropane) diacrylate; di(trimethylolpropane) triacrylate; di(trimethylolpropane) tetraacrylate, sorbitol penta(meth)acrylate; di(pentaerythritol) tetraacrylate; di(pentaerythritol) pentaacrylate; di(pentaerythritol) hexa(meth)acrylate; tris (2-hydroxyethyl) isocyanurate tri(meth)acrylate; as well as the alkoxylated (e.g., ethoxylated and/or propoxylated) derivatives thereof, and combinations thereof.

Clause 26. The curable composition of any one of clauses 23-25, wherein the curable composition is substantially free of a photoinitiator other than the oligomer according to any one of clauses 1 to 21, in particular, the curable composition comprises less than 0.1%, in particular less than 0.05%, more particularly less than 0.001%, even more particularly 0% by weight of photoinitiator other than the oligomer according to any one of clauses 1 to 21.

Clause 27. A coating formed by curing the ultraviolet curable composition of any of clauses 22 to 26.

Clause 28. The coating of clause 27, wherein the coating has a gel content of at least 30%.

Clause 29. The coating of clause 27 or 28, wherein the coating has a gel content of at least 50%.

Clause 30. The coating of any one of clauses 27 to 29, wherein the coating has a gel content of at least 70%.

Clause 31. A method of preparing the curable composition of any one of clauses 23 to 26, wherein the method comprises the following steps:
preparing an oligomer as defined in any one of clauses 1 to 21 dissolved in a non-reactive solvent;
adding a reactive diluent to obtain a diluted curable composition;
removing at least part of the non-reactive solvent from the diluted curable composition to obtain the curable composition according to the invention.

Clause 32. A method of curing the curable composition of any one of clauses 23 to 26 or prepared according to the method of clause 31, wherein the method comprises curing the curable composition by irradiating the curable composition with a light source having a wavelength and/or an intensity that is able to activate the polymerized chromophore monomer units of the oligomer and cause crosslinking of said oligomer and/or said reactive diluent.

It will be apparent to persons of ordinary skill in the art that various modifications and variations can be made without departing from the scope disclosed herein. Since modifications, combinations, sub-combinations, and variations of the disclosed embodiments, which incorporate the spirit and substance disclosed herein, may occur to persons of ordinary skill in the art, the scope disclosed herein should be construed to include everything within the scope of the appended claims and their equivalents.

For the purposes of defining the present technology, the transitional phrase “consisting of” may be introduced in the claims as a closed preamble term limiting the scope of the claims to the recited components or steps and any naturally occurring impurities. For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter.

As used in the Specification and appended Claims, the singular forms “a”, “an”, and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced.

It should be understood that any two quantitative values assigned to a property may constitute a range of that property, and all combinations of ranges formed from all stated quantitative values of a given property are contemplated in this disclosure. The subject matter disclosed herein has been described in detail and by reference to specific embodiments. It should be understood that any detailed description of a component or feature of an embodiment does not necessarily imply that the component or feature is essential to the particular embodiment or to any other embodiment.

1. An oligomer comprising, based on the total weight of the oligomer:
from 1% to 95% by weight polymerized high-T_{g} monomer units;
from 0.1% to 98.9% by weight polymerized low-T_{g} monomer units;
from 0.1% to 40% by weight polymerized chromophore monomer units; and
from 0 to 20% by weight of at least one polymerized additional monomer unit;
wherein:
the high-T_{g} monomer units are (meth)acrylate monomers having a Fox Equation average glass transition temperature (T_{g}) equal to or greater than 25 °C;
the low-Tₐ monomer units are monovalent (meth)acrylate monomers having a Fox Equation average T_{g} less than 25 °C;
the Fox Equation average T_{g} of the high-T_{g} monomer units is at least 20 °C greater than the Fox Equation average T_{g} of the low-T_{g} monomer units;
the chromophore monomer units are (meth)acrylate monomers having a pendent Norrish Type II chromophore;
the oligomer has a weight average molecular weight of at least 10,000 grams per mole (g/mol); and
the oligomer has a T_{g} equal to or greater than 0 °C.

2. The oligomer of claim 1, according to formula (I): 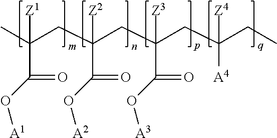
each A¹ is independently (C₁-C₃₀)hydrocarbyl or (C₁-C₃₀)heterohydrocarbyl;
each A² is independently (C₂-C₃₀)hydrocarbyl or (C₂-C₃₀)heterohydrocarbyl;
each A³ is independently a monovalent residue comprising the Norrish Type II chromophore;
each A⁴ is independently a (C₁-C₃₀)hydrocarbyl or (C₁-C₃)heterohydrocarbyl;
Z¹, Z², Z³, and Z⁴ are independently —H or —CH₃;
m is a weight fraction of the polymerized high-T_{g} monomer units;
n is a weight fraction of the polymerized low-T_{g} monomer units;
p is a weight fraction of the polymerized chromophore monomer units;
q is a weight fraction of the at least one polymerized additional monomer units and optionally is zero; and
m+n+p+q is equal to 1.

3. The oligomer of claim 2, wherein:
at least part of the A¹ moieties is chosen from isobutyl, tert-butyl, a substituted or unsubstituted (C₆-C₁₂)cycloalkyl optionally combined with an alkylene moiety, a substituted or unsubstituted (C₆-C₁₂)aryl optionally combined with an alkylene or oxyalkylene moiety, or combinations thereof;
A² is a linear or branched (C₂-C₃₀)alkyl or combinations thereof; and
A³ is X or -L-X, where L is a (C₁-C₁₀)heterohydrocarbylene linker and X is a monovalent residue of the Norrish Type II chromophore.

4. The oligomer of claim 2, wherein:
at least part of the A¹ moieties is chosen from isobutyl, tert-butyl, isobornyl, cyclohexyl, 3,3,5-trimethylcyclohexyl, tert-butylcyclohexyl, benzyl, adamantyl, dicyclopentanyl, tricyclodecyl, —CH₂-tricyclodecyl, phenyl, —CH₂—CH₂-phenyl, or —CH₂—CH₂—O-phenyl;
A² is chosen from n-butyl, isobutyl, hexyl, 2-ethylhexyl, isooctyl, isodecyl, tridecyl, lauryl, or combinations thereof; and
A³ is a monovalent residue of the Norrish Type II chromophore.

5. The oligomer of claim 1, wherein the Norrish Type II chromophore is chosen from benzophenones, thioxanthones, or titanocenes.

6. The oligomer of claim 2, wherein A³ is a monovalent residue of benzophenone.

7. The oligomer of claim 2, wherein:
at least part of the A¹ moieties is chosen from isobutyl, tert-butyl, isobornyl, cyclohexyl, 3,3,5-trimethylcyclohexyl, tert-butylcyclohexyl, benzyl, adamantyl, dicyclopentanyl, tricyclodecyl, —CH₂-tricyclodecyl, phenyl, —CH₂—CH₂-phenyl, or —CH₂—CH₂—O-phenylA² is n-butyl; and
A³ is a monovalent residue of benzophenone.

8. The oligomer of claim 2, wherein A³ has formula (IVa):

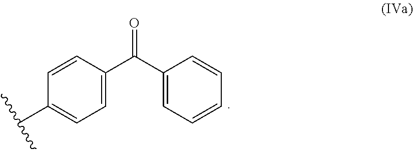 [SMILES: *c1ccc(C(=O)c2ccccc2)cc1]

9. The oligomer of claim 2, wherein:
q is from 0.001 to 0.20; and
the additional monomer units comprise a functional group selected from an acidic group, a heterocycle with one or more nitrogen ring atoms, tertiary amine functionality, alkylenoxy functionality or a mercaptan group.

10. The oligomer of claim 2, wherein the oligomer is according to formula (V): 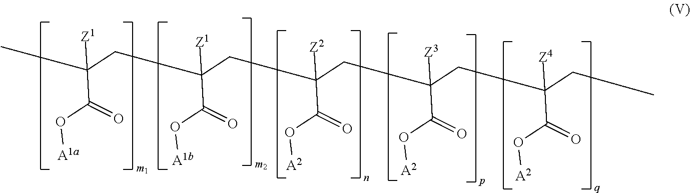
wherein:
each A^{1a} is independently chosen from isobutyl, tert-butyl or a cyclic (C₁-C₃₀)hydrocarbyl;
each A^{1b} is independently chosen from a (C₁-C₃₀)hydrocarbyl other than isobutyl, tert-butyl or a cyclic (C₁-C₃₀)hydrocarbyl;
each A² is independently (C₂-C₃₀)hydrocarbyl or (C₂-C₃₀)heterohydrocarbyl;
each A³ is independently a monovalent residue comprising the Norrish Type II chromophore;
each A⁴ is independently a (C₁-C₃₀)hydrocarbyl or (C₁-C₃₀)heterohydrocarbyl;
Z¹, Z², Z³, and Z⁴ are independently —H or —CH₃;
m₁ is 0.01 to 0.95;
m₂ is 0 to 0.94;
n is 0.001 to 0.989;
p is 0.001 to 0.40;
q is 0 to 0.20; and
m₁+m₂+n+p+q is equal to 1;
m₁+m₂ is from 0.01 to 0.95.

11. The oligomer of claim 2, according to formula (VI): 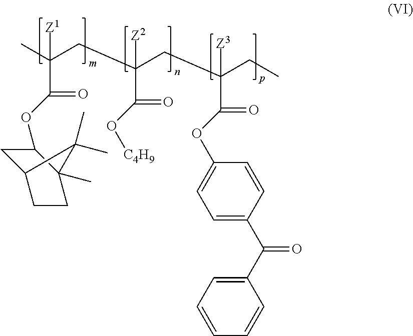
where:
m is from 0.2 to 0.8;
n is from 0.1 to 0.8; and
p is from 0.001 to 0.2;
wherein:
the oligomer has a weight average molecular weight of at least 20,000 g/mol.

12. The oligomer of claim 2, wherein:
Z¹ is —CH₃;
Z², and Z³ are —H; and
Z⁴ is —H, if q is greater than 0.

13. The oligomer of claim 1, wherein the T_{g} of the oligomer is from 0 °C to 100 °C.

14. A curable composition comprising the oligomer according to claim 1 and a reactive diluent.

15. The curable composition of claim 14, wherein the reactive diluent comprises a monofunctional (meth)acrylate monomer having a Tg that is higher than 25 °C.

16. The curable composition of claim 14, wherein the reactive diluent comprises a polyfunctional (meth)acrylate.

17. The curable composition of claim 14, wherein the curable composition is substantially free of a photoinitiator other than the oligomer.

18. A coating formed by curing the ultraviolet curable composition of claim 14.

19. The coating of claim 18, wherein the coating has a gel content of at least 30%.

20. A method of preparing a curable composition of, wherein the method comprises the following steps:
preparing an oligomer as defined in claim 1 dissolved in a non-reactive solvent;
adding a reactive diluent to obtain a diluted curable composition;
removing at least part of the non-reactive solvent from the diluted curable composition to obtain the curable composition.

21. A method of curing the curable composition of claim 14 wherein the method comprises curing the curable composition by irradiating the curable composition with a light source having a wavelength and/or an intensity that is able to activate the polymerized chromophore monomer units of the oligomer and cause crosslinking of said oligomer and/or said reactive diluent.
